(19) United States
(12) Patent Application Publication
(10) Pub. No.: US 2014/0108293 A1
(43) Pub. Date: Apr. 17, 2014

(54) SYSTEMS AND METHODS FOR TRADING, TRACKING, AND MANAGING CONFIGURABLE PORTFOLIO BASKETS

(71) Applicant: Optionshop. Inc., Chicago, IL (US)

(72) Inventors: Brian Barrett, Chicago, IL (US); David Karrow, Chicago, IL (US); Grant Cupps, Chicago, IL (US); Robert G. Fitzsimmons, Chicago, IL (US)

(73) Assignee: Optionshop. Inc., Chicago, IL (US)

(21) Appl. No.: 14/028,483

(22) Filed: Sep. 16, 2013

Related U.S. Application Data
(60) Provisional application No. 61/778,301, filed on Mar. 12, 2013.
(60) Provisional application No. 61/701,583, filed on Sep. 14, 2012.

(51) Int. Cl. G06Q 40/04

(52) U.S. Cl. CPC G06Q 40/04; G06Q 40/06
USPC 705/36 R

(57) ABSTRACT

A system and method for establishing, tracking, and managing a user-configurable portfolio basket is provided. The system provides a plurality of pre-determined, user-selectable portfolio baskets, wherein said portfolio baskets include a plurality of products of at least one asset class. The user then selects one of the portfolio baskets, and sets a lower delta, an upper delta, and a time selection to be associated with said basket. These are then used by the system to determine trading instruments for each of the plurality of products in the basket. The trades represented by the instruments in the basket are then reviewed to confirm the authorization of the user to trade them and, if so, the trade is placed as a basket. Further, the performance of the instruments is tracked as a basket and the user may later add instruments to or sell instruments from the portfolio basket.

### CROSS-REFERENCE TO RELATED APPLICATIONS

The present application claims the benefit of U.S. Provisional Application No. 61/701,583, filed Sep. 14, 2012, entitled “System and Method For Trading Using Configurable Portfolio Baskets” and U.S. Provisional Application No. 61/778,301, filed Mar. 12, 2013, entitled “System and Method For Trading Using Configurable Portfolio Baskets”

### BACKGROUND OF THE INVENTION

The present invention generally relates to a computerized trading system. More particularly, the present invention relates to a computerized trading system allowing a portfolio of instruments to be constructed, traded, and tracked as a basket.

Computerized trading systems for financial instruments such as securities, derivatives, options, futures, and bonds have been available for some time. However, prior computerized trading systems are typically constructed to perform individual trades of a security, such as buying 100 shares of AT&T, for example.

Conversely, a more sophisticated trader may wish to establish a portfolio of financial instruments based on the trader's belief that a certain market condition may come to pass. The sophisticated trader often used several financial instruments in the portfolio to diversify risk and may also user options and futures. However, establishing the portfolio may be laborious and slow. First, the trader must determine the number of individual financial instruments to add to the portfolio. Then, for each financial instrument, the trader must execute an individual trade. Additionally, the trader may succeed in assembling a portion of the portfolio, but then be unable to complete construction of the portfolio due to addition cash and/or margin requirements. Further, the trader does not have any automated system for tracking the performance of the portfolio as a whole.

### BRIEF SUMMARY OF THE INVENTION

One or more of the embodiments of the present invention provide a system and method for establishing, tracking, and managing user-configurable portfolio baskets. A plurality of pre-determined, user-selectable portfolio baskets are provided. The portfolio baskets include a plurality of products of at least one asset class. The user then selects one of the portfolio baskets and chooses the direction they believe the market will move (by choosing a lower delta and an upper delta), and a time-frame within which the user expects the products within the basket to move. The lower delta, upper delta, and time selection are then used by the system to determine trading instruments for each of the plurality of products in the basket. The trades represented by the instruments in the basket are then reviewed by the user and submitted to risk checks in the system. If the trades are withing the user's risk parameters, the trades are submitted to the exchange, and represented to the user as a basket. Further, the performance of the instruments are tracked as a basket and the user may later add instruments to or sell instruments from the portfolio basket, and trade the entire basket with a single click as though it were one security

### BRIEF DESCRIPTION OF THE DRAWINGS

FIG. 1 illustrates an introduction page of a configurable portfolio basket trading system according to an embodiment of the present invention.

FIG. 2 illustrates a baskets menu page.

FIG. 3 illustrates a diversified baskets page.

FIG. 4 illustrates an agricultural baskets page.

FIG. 5 illustrates an FX basket page, where FX is short for a foreign-exchange option or currency option.

FIG. 6 illustrates an interest rate basket page.

FIG. 7 illustrates the diversified baskets page of FIG. 3 displaying the asset class selection menu when the add product button has been pressed.

FIG. 8 illustrates the chart of possible outcomes, as shown at the bottom of the web pages for the diversified basket, agricultural basket, FX basket, and interest rates basket.

FIG. 9 illustrates an alternative embodiment of the diversified basket webpage of FIG. 3.

FIG. 10 illustrates the finalize your trade webpage that is displayed when the trader activates the next step button.

FIG. 11 illustrates the trade fail screen.

FIG. 12 illustrates a basket details page.

FIG. 13 illustrates an alternative finalize your trade webpage similar to that of FIG. 10 that is displayed when the trader activates the next step button.

FIG. 14 is a system diagram illustrating the components of one embodiment of the present configurable portfolio basket trading system.

FIG. 15 illustrates a diversified baskets page with a delta double slider having a left delta selector with settings of buying 0.3 deltas and a right delta selector with settings of selling 0.1 deltas in a series of theme trade related user defined, system processed vertical option spreads.

FIG. 16 illustrates a diversified baskets page with a delta double slider having a left delta selector with settings of buying 0.35 deltas and a right delta selector that has been disengaged by the user so that the user has instructed the system to perform outright option trades

FIG. 17 illustrates a flowchart of an embodiment of the present system.

FIG. 18 illustrates a flowchart of the setup of the configurable portfolio basket trading system.

FIG. 19 illustrates a flowchart of accepting or amending call option contracts as part of the present system.

FIG. 20 illustrates a flowchart of accepting or amending financing for trading the basket.

FIG. 21 illustrates a flowchart of selecting the instrument type to execute and entering a trading order.

FIG. 22 illustrates a flowchart of an order entry system.

FIG. 23 illustrates a flowchart 2300 of the process of weighting risk across a basket according to one embodiment of the invention.

FIG. 24 illustrates the ATM-OTM time rates of decay 2400.

### DETAILED DESCRIPTION OF THE INVENTION

One or more embodiments of the present invention provide configurable portfolio baskets. The configurable portfolio baskets may allow traders or investors to quickly and efficiently execute trading strategies, for example, based on sector specific or macro theme trades involving several markets. Additionally, in one or more embodiments, the present system may allow traders to monitor the performance of the positions in the baskets individually or as a basket as a whole. Additionally, even after the initial trade, the configurable basket may be modified by the trader to add or eliminate positions from the basket. Alternatively, all positions in the basket may be sold at once, bought back, and traded as though they were a single security.

For example, if a trader believes the historically unprecedented accommodative monetary policy emanating out of the U.S. Federal Reserve is soon to be reined in, he may expect prices of hard and financial assets to fall in the near future. The trader may then choose to initiate a ‘Diversified Short’ basket (as further described below) within which short positions may be assumed across the six major sectors of the futures markets. The trader may also select a customized list of products to create a Basket in which the trader is buying or selling any combination of securities.

In one embodiment, the present system may automatically construct a configurable portfolio basket comprised of the most liquid products within each sector. For example, in the category of agriculture, the most liquid product may be corn; in the category of metals, the most liquid product may be gold; in the category of energies, the most liquid product may be crude oil; in the category of currencies, the most liquid product may be the euro; in the category of treasuries, the most liquid product may be the year treasury; and in the category of stock indices, the most liquid product may be the e-mini S&P.

In one embodiment, the system may then ask the trader to pick a direction representing the expected change in price up or down of the sector, a general expectation of price change representing the expected price change in a sector, and a time frame representing the expected time for the sector price change to occur. From the trader inputs, in one embodiment the system may then adjust one or more of the trading instruments or futures in the sectors in order to maximize the profitability of the sector or basket in light of the expected movement, as further discussed below.

Thus, in one or more embodiments, the present system provides an advantage to the trader because the trader is freed from having to seek out and manually enter relevant strikes and expirations for each trade in each market of each sector. As further discussed below, the system may match relative price movement expectations across markets that are non-standardized with regard to volatilities and expirations. The trader may choose to further balance his basket by adjusting the number of contracts assumed in each sector according to the margining regime of the exchange, for example, the CME SPAN (Standard Portfolio Analysis of Risk) margining requirements, thus adjusting for both the different volatilities and the different contract sizes of these non-standardized products.

To accommodate the trader in this multi-market, multi-contract strategic trade implementation, the present system initially defaults to ‘vertical’ option spreads. A vertical spread is an options strategy involving buying and selling of multiple options of the same underlying security, same expiration date, but at different strike prices. They can be created with either all calls or all puts. The term originates from the trading sheets that were used in the open outcry pits on which option prices were listed out by expiry date & strike price, thus looking down the sheet (vertical) the trader would see all options of the same maturity. Using vertical option spreads may reduce the overall cost of the strategic trade implementation.

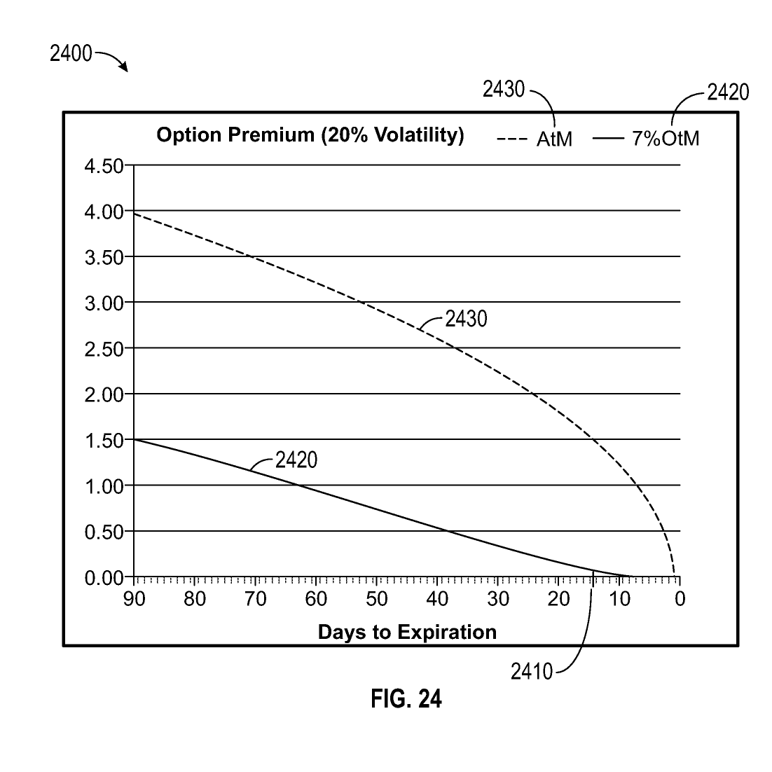

By adopting vertical option spreads, the present system may also lessen the impact of ‘time decay’ inherent in options by being both long and short options within each sector contract. The system also accounts for the impact of the differing rates of time decay for ATM (at-the-money) and OTM (out-of-money) options within each spread by insuring that the baskets contain only options spreads with sufficient time to expiration. For example, FIG. 24 illustrates the ATM-OTM time rates of decay 2400. As shown in FIG. 24, as the time to expiration approaches, the spread between ATM 2430 and OTM 2420 contracts, which may make it unappealing to a trader. In one embodiment, the 14 Day to Expiration point 2410 is determined to be the point at which the trader may become unattractive. Thus, the system calculates the shortest DTE or Days to Expiration of the component instruments in a basket and makes sure it has a minimum of 14 DTE upon user chosen time horizon Basket exit date. This helps the user avoid trading contracts that have an accelerated rate of decay as they approach expiration. Such spread trading also negates much of the risk associated with changes in volatility of any one of the components within the strategy. Yet the specific products, the number of products, the trade type, the direction of each trade, the buying and/or selling of option premium, the time frame, and the price expectation all remain configurable to the trader.

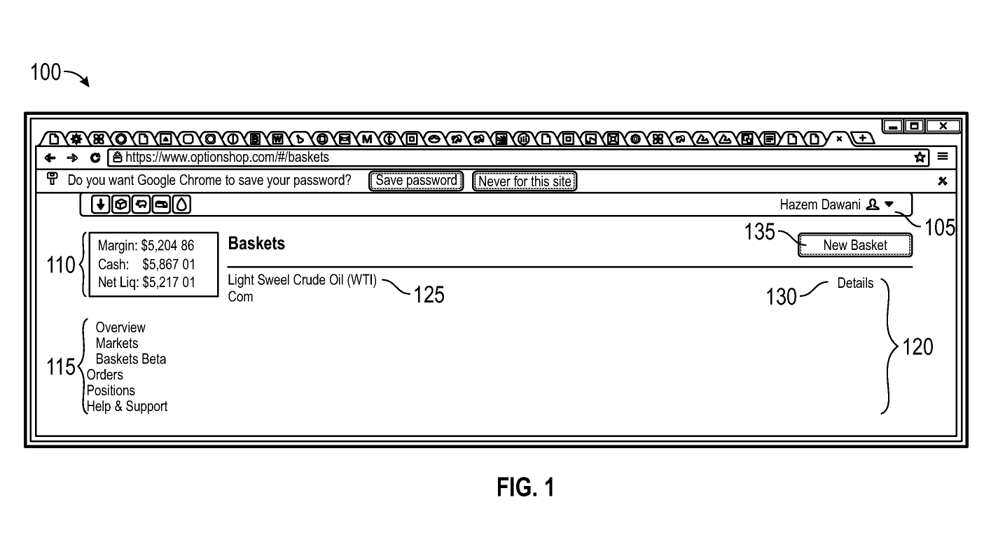

FIG. 1 illustrates an introduction page 100 of a configurable portfolio basket trading system according to an embodiment of the present invention. As shown in FIG. 1, the introduction page 100 includes a trading account identifier and setup 105, a financial account summary 110, a page menu 115, a baskets list 120, a basket identifier 125, a basket details button 130, and a new basket button 135.

In operation, the trading account identifier and setup 105 may display the name or other identifier of the trader owning the account. The trading account identifier and setup 105 may also provide a dropdown menu displaying account setup options such as login information.

The financial account summary 110 includes a listing of the cash value and margin value associated with the trader's account. The sum of the cash value and the margin value is the net liquidity, which is the total amount of funds available for trading.

The page menu 115 includes links to the various pages of the configurable portfolio basket trading system including an overview page, a markets page, a baskets page, an order page, a positions page and a help page.

The baskets list 120 lists all baskets that are associated with the account. Currently only a single basket is listed. The basket is identified by the basket identifier 125 as “Light Sweet Crude Oil (WTI) Corn.

When selected, the details button 130 causes a new page showing the details of the basket to be shown. Each basket in the baskets list 120 is preferably associated with its own details button. The details of the basket are further illustrated below.

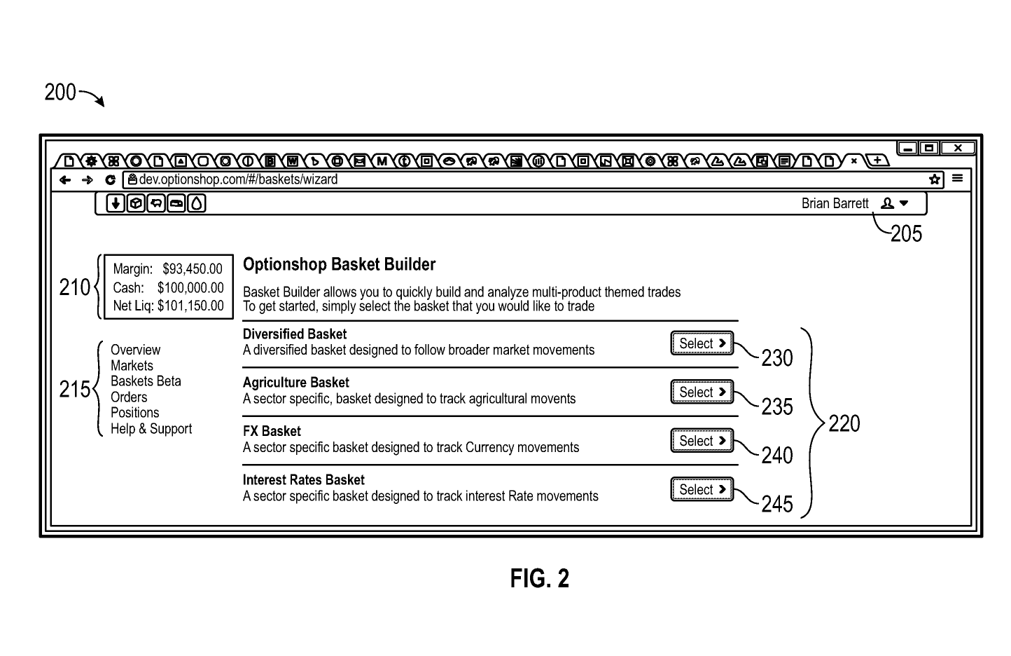

The new basket button 135 may be selected by a user to move the user to the baskets menu page shown in FIG. 2 below.

FIG. 2 illustrates a baskets menu page 200. The baskets menu page 200 includes a trading account identifier and setup 205, a financial account summary 210, a page menu 215, and a baskets selection menu 220. The baskets selection menu 220 includes selectable entries for a diversified basket 230, an agriculture basket 235, a FX basket 240, and an interest rates basket 245.

In FIG. 2, the trading account identifier and setup 205, financial account summary 210, and page menu 215 function similarly as in FIG. 1. The baskets selection menu 220 allows the trader to select any one of the available basket types (including but not limited to, diversified basket selection button 230, agricultural basket selection button 235, FX basket selection button 240, and interest rates basket selection button 245) or a fully customized basket, and then causes a new page to be displayed showing a default basket of the selected type to be displayed as shown below. The new pages that are displayed when each of the baskets are selected are illustrated below.

The interest rates basket is a sector specific basket designed to track interest rate movements. The FX basket is a sector specific basket designed to track currency movements. The agricultural basket is a sector specific basket designed to track agricultural movements. The diversified basket is designed to follow broader market movements, typically across sectors. Although not shown in FIG. 2, but described further below, FIG. 2 may alternatively include a 401k/IRA basket that is designed to track a standard retirement portfolio.

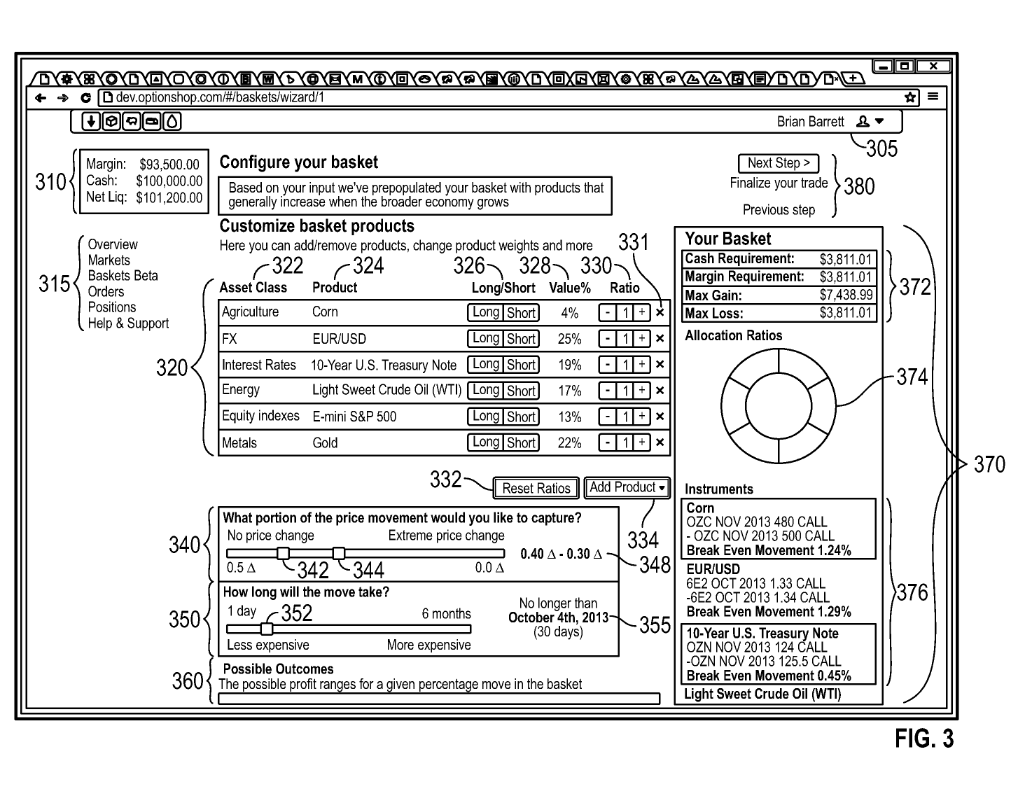

FIG. 3 illustrates a diversified baskets page 300. The diversified basket page is displayed when the trader activates the diversified basket selection button 230 of the baskets menu page 200.

The diversified baskets page 300 includes a trading account identifier and setup 305, a financial account summary 310, and a page menu 315 that operate similarly to those shown in FIG. 1.

Additionally, the diversified baskets page 300 includes a basket product display 320. The basket product display 320 includes a listing of assets classes 322, products 324, long/short selector 326, basket value percentage 328, a ratio selector 330, and a product deletion button 331 for each entry that has been selected for the basket.

As shown in FIG. 3, in the basket product display 320, for the selected asset class of agriculture, the product of corn futures derivatives is shown, thus corn futures derivatives are used. For the selected asset class of FX, the product derivatives of EUR/USD are used. For the selected asset class of interest rates, the product derivatives of 10 year US treasury notes are used. For the selected asset class of energy, the product derivatives of Light Sweet Crude Oil (WTI) are used. For the selected asset class of equity indices, the product derivatives of E-mini S&P 500 are used. For the selected asset class of metals, the product derivatives of gold are used.

In a first embodiment of the system, the diversified baskets page defaults to creating a basket with each of the indicated asset classes: agriculture, FX, interest rates, energy, equity indexes, and metals.

Within each asset class, the system identifies a specific product as a default. In a first embodiment, the system identifies the product by identifying the product within the asset class having the greatest liquidity. In another embodiment, the system identifies the product having the lowest standard deviation in the change of the underlying volatility over a time period, such as one month, three months, six months, or a trader-selectable number of months.

The liquidity of a product may be assessed for determining whether to include the product for that asset class in a variety of ways. For example, the system may identify the product with the greatest number of currently outstanding contracts. Alternatively, the system may use a periodically published listing of the trading volume of the products to identify the product having the highest liquidity.

The diversified baskets page 300 also includes a long/short selector 326. The long/short selector 326 may be used by the trader to select whether the trader wishes to go long or short for the specific product chosen in that asset class. For example, for the asset class of agriculture and the product of corn, if the trader selects long, then the trader indicated that he wishes to establish a position wherein the value of the position will rise if the value of corn rises. Conversely, by selecting short, then the trader has indicated that he wishes to establish a position wherein the dollar value of the position will rise if the value of corn falls.

Each of the products is associated with a long/short selector 326. Consequently, the trader may diversify their trading basket as they see fit. For example, if the trader believes that all products will rise in value, then the trader may remain long for all products. Conversely, if the trader believes that all products will fall in value, then the trader may select short for all products. Additionally, if the trader believes that some of the products will rise in value and others fall, then the trader may select long for the products that are expected to rise in value and short for the products expected to fall in value.

For example, if a trader believes that the price of a product is going to fall and the trader selects short for the product, the system then uses one or more of long put spreads and short call spreads.

Returning to the diversified baskets page 300, we also see that each product is associated with a basket value percentage 328. The basket value percentage 328 is the percentage of the value of the current basket represented by each product. In one embodiment, one future is selected for each product and the relative value of each contract represents the basket percentage 328. In another embodiment, the total desired value of the basket is used to find a lowest common multiple of contacts for each product that approximates an even split among the asset classes currently in the basket.

Additionally, the ratio selector 330 may be used for each product to adjust up or down the number of contracts for that product to include in the basket. Thus, as shown in FIG. 3, the basket is initially formed using a single contract for each product and the number of contracts is shown in the ratio selector 330 and the relative percentage value of the basket for each product is shown in the basket value percentage 328. The trader may then toggle up or down the total number of contracts for each product using the plus or minus toggle of the ratio selector. As the number of contracts is changed, the basket value percentage for all products is changed to indicate the new basket percentage.

As shown in FIG. 3, each product also includes a product deletion button 331. The product deletion button 331 may be used to remove the product from the basket. For example, a trader may have a strong opinion about corn and gold, but may not wish to establish a long or short position in 10 year treasury notes. Consequently, the trader may eliminate the 10 year treasury note position from the basket be selecting its associated product deletion button.

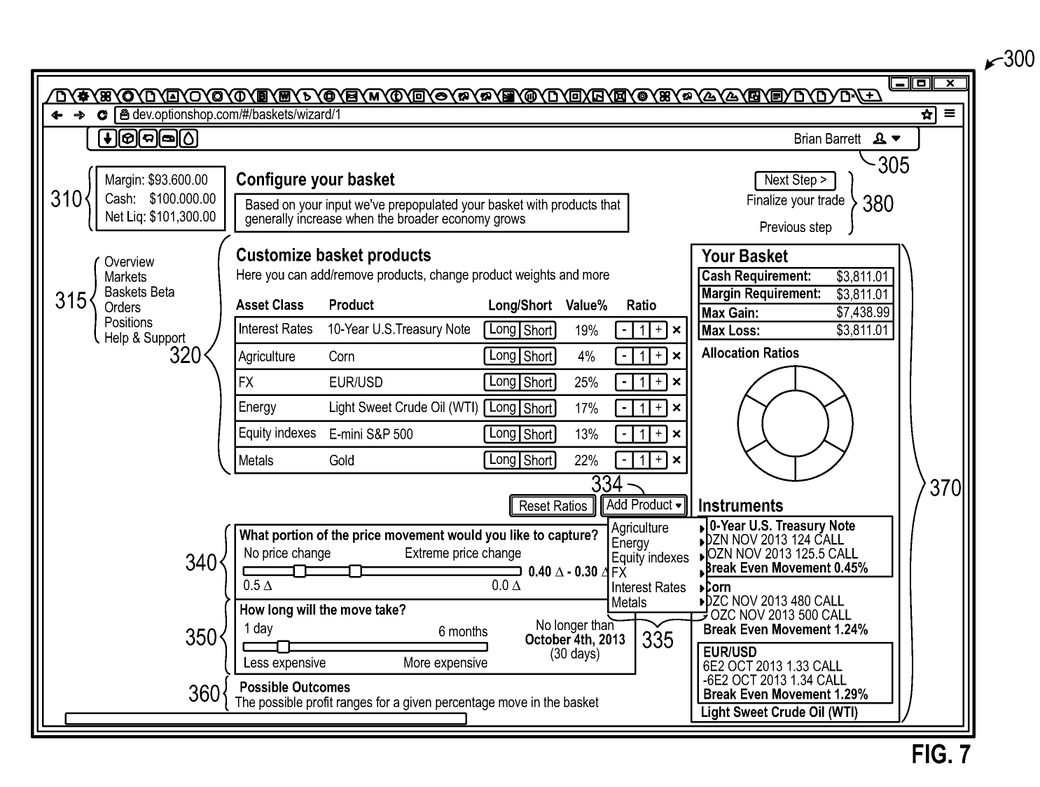

Similarly, if the trader wishes to add a product, the trader may select the add product button 334. As shown below in FIG. 7, when the add product button 334 is selected a drop-down menu of all asset classes is displayed for selection by the trader. Once the trader selects an asset class, the system preferably displays an additional drop-drop-down menu listing products in that asset class. The trader may then select a product and the product will be added to the basket. The newly added product is displayed as its own line listing asset class, product, long/short, value percentage, ratio, and delete button.

FIG. 3 also shows a reset ratios button 332. When the rest ratios button is selected, the number of contracts for each product is reset to one and the basket value percentage 328 changes to reflect the new ratio. In another embodiment, the ratios may be reset based on the exchange margin per product. In another embodiment, the rations may be reset by notional value of each product.

FIG. 3 also includes a delta double slider 340. The delta double slider 340 includes a left delta selector 342, a right delta selector 344, and a current delta selection indicator 348. With regard to the delta double slider 340, when building the strategy components; the wider the sliders are set, the more of any given move in the basket is captured, and thus the greater the total payout potential. The cash requirement is also greater, yet the BEP (break-even-point) requires less of a market move.

Conversely, the closer together the sliders are set, the lower the variance in basket valuation in response to price changes of the underlying products. This may limit the total payout, but may reduce losses in the event that the products in the basket experience and undesired price change. Additionally, the cash requirement may be less, but the BEP may require more movement of the products in the basket.

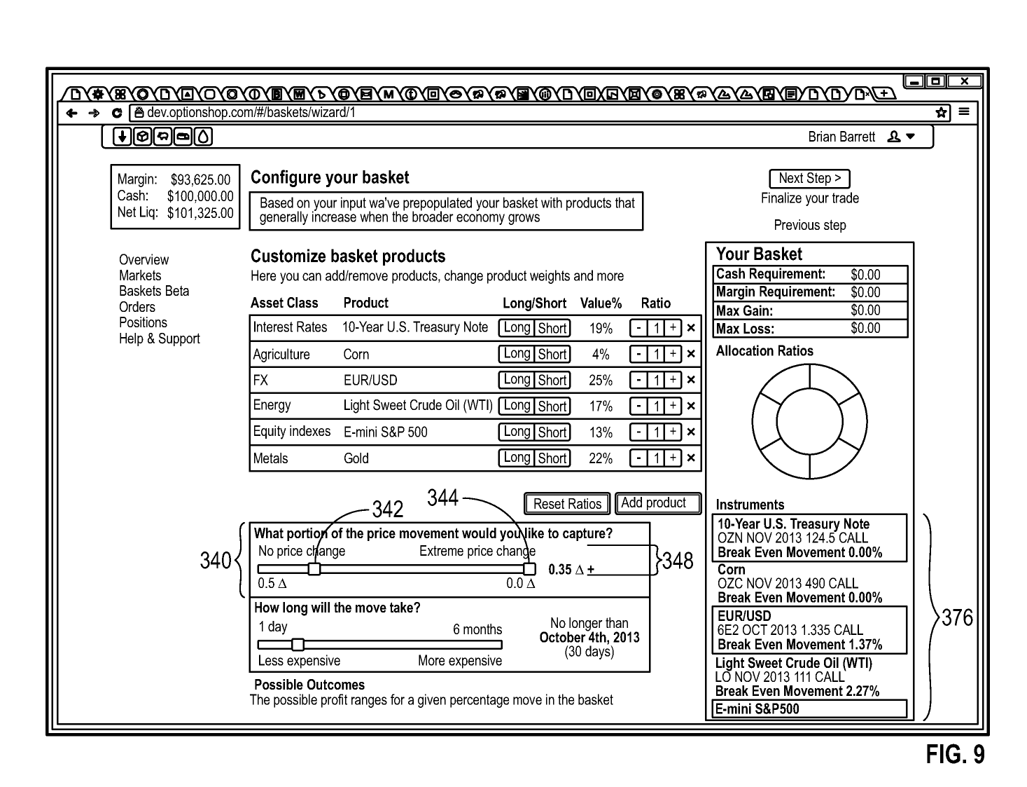

Note how, in one embodiment, the scale is in deltas and to the right of the scale the trader may observe the related long and short delta of the spreads he has configured. The trader may manipulate the sliders until he finds an optimum relationship between his market expectations, his cash and margin requirements, his max gain/loss ratio, and his BEP. The use of the delta double slider 340 is further discussed below in FIG. 9

Turning again to FIG. 3, we see that the diversified baskets page 300 includes a timing selector 350. The timing selector 350 includes a time slider 352, and a securities timing indicator 355. The timing selector 350 allows a trader to select the expected time frame for the market movement that they are attempting to capture with the basket and may range from 1 day to 1 year. Selecting a lesser time frame may allow the underlying products to be purchased more cheaply than a longer time frame due to the time-to-expiration value inherent in futures, options, and other derivatives.

Once the trader selects a time frame, the system proceeds to the next subsequent future, option, or other derivative expiration date after the selected time frame for each product in the basket and then selects the product from that expiration date for inclusion in the basket.

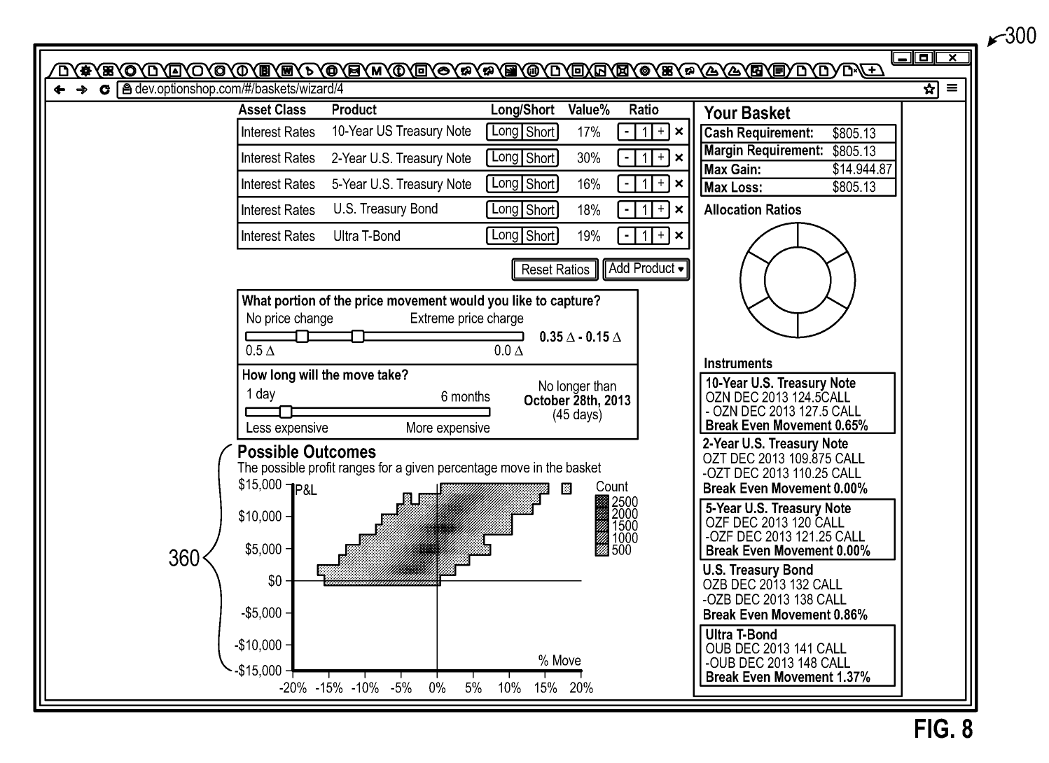

Turning again to FIG. 3, a chart of the possible outcomes representing the distribution of payouts for a given percentage move in the basket is displayed. A detailed representation of the chart of possible outcomes 360 is displayed below in FIG. 8. Possible outcomes may be determined based on Monte-Carlo simulation.

FIG. 3 also includes a basket summary column 370. The basket summary column 370 includes a basket value summary 372, a basket ratio graphic 374, and a basket instrument detail display 376. The basket value summary 372 displays the cash requirement and margin requirement needed to trade the basket, as well as the maximum gain and loss that trading the current basket may produce.

The basket ratio graphic 374 may graphically display the relative portions of the portfolio represented by each product. As shown in FIG. 3, one contract of each product is being included in the basket. Consequently, the basket ratio graphic 374 is evenly divided. However, when a trader alters the number of contracts by using the ratio selector 330, the basket ratio graphic 374 also changes to show the new ratio of contract numbers in the basket. Alternatively, in another embodiment, the basket ratio graphic shows the relative notional value, in a currency of the users choice, of each product in the basket rather than the number of contracts, and the total notional value of the basket is shown in the center of the graphic.

The basket instrument display 376 includes an entry for each product in the basket. As shown in FIG. 3, the first entry is the corn product—as indicated selected in the basket product display 320. Within the corn product it can be seen that the position includes two futures, a purchase of the CME's OZC November 2013 480 CALL and a sale of the OZC November 2013 500 CALL. These specific futures were determined based on the indications provided by the trader in the delta double slider 340 and timing selector 350.

More specifically, as mentioned above, the timing selector allows the trader to set when the trader believes the desired market move will have taken place, for example, no later than Oct. 4, 2013. The system may then advance to the closest futures, options, or futures options expiration following the end of the users specified time frame, and plan to make a futures purchase and/or sale for the NOV 2013 call.

Additionally, the delta double slider 340 allows the trader to set how much of the price increase (or decrease if the product is set to short) that they will capture. More specifically, the left delta selector 342 sets the future to purchase based on the delta from the current future price. In this case, the left delta selector 342 is set to 0.4 delta and based on the current price of the corn future and the 0.4 delta ratio, a 480 CALL is thus determined to be the closest match—and is thus added to the basket to be purchased.

In one embodiment, the call is determined to be the closest match because, under the pricing model that is being run, the system determines that the delta of this option is closer to 0.4 than that of any other option.

Similarly, the right delta selector is set to 0.3 delta and based on the current price of the corn future and the 0.3 delta ratio a 500 CALL is determined to be the closest match—and is thus added to the basket to be sold. The sale of the second option or futures option may be used to generate cash to lessen the total cash needed to purchase the first future, thus lowering the overall cost of the basket

If the left delta selector 342 is slid all the way to the left, then the system purchases an option or futures option as close to the current future price/at-the-money (ATM) as possible. Conversely, sliding the right delta selector 344 to the right causes the system to sell futures further and further away from the money, until it is slid all the way to the right where no option or futures option is sold.

The specific option or futures options shown in the basket instrument display 376 update in real time as the trader modifies the basket product display 320, the delta double slider 340, and timing selector 350. Further, the basket value summary 372 updates in real time to reflect the current exchange prices for the underlying futures.

Additionally, the basket instrument display 376 shows the Break Even Point (BEP) for each product. For this example, for the corn product which includes the purchase of a call on a future and the sale of a call on a future, the BEP is shown to be a price movement in the underlying corn future of 1.24%.

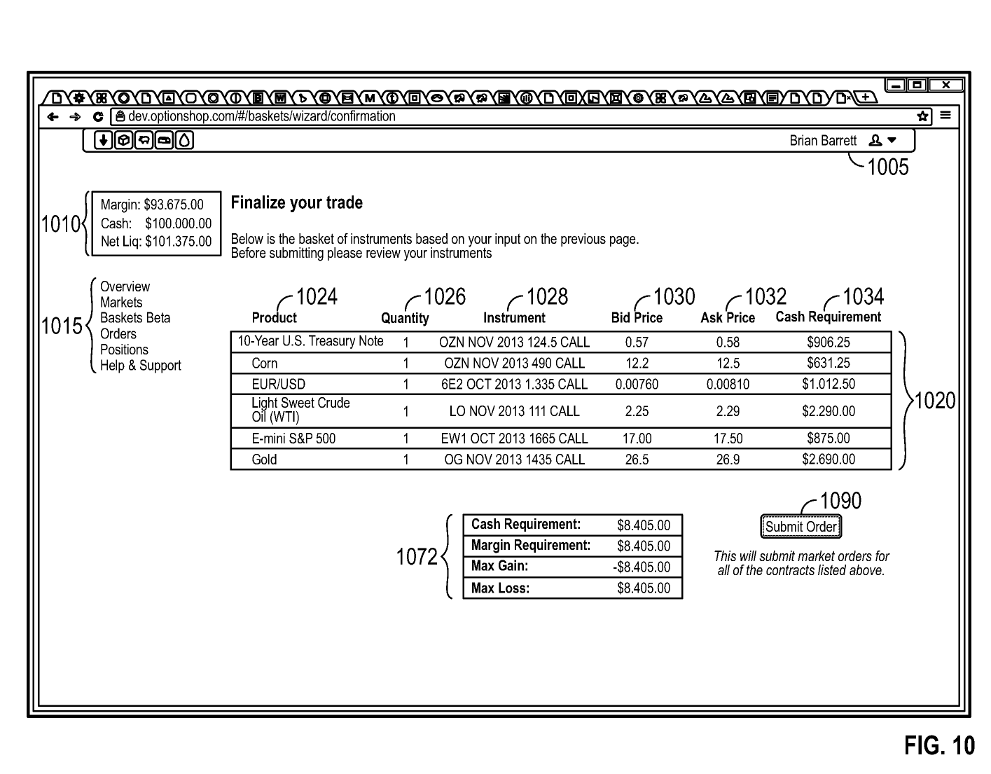

Finally, once the trader is satisfied with the basket composition, the trader clicks the next step button 380 to see the proposed all-in-one trade submission, for example as shown in FIG. 10. As shown below in FIG. 10, if the bid/ask spreads show sufficient liquidity, as judged by the user, and if the final estimate of the cash requirements are deemed acceptable, the trader may click the Submit Order button to actuate the trade. In one embodiment, the system first automatically RFQs each options spread or product in order to get the latest market data, and hopefully a tighter market.

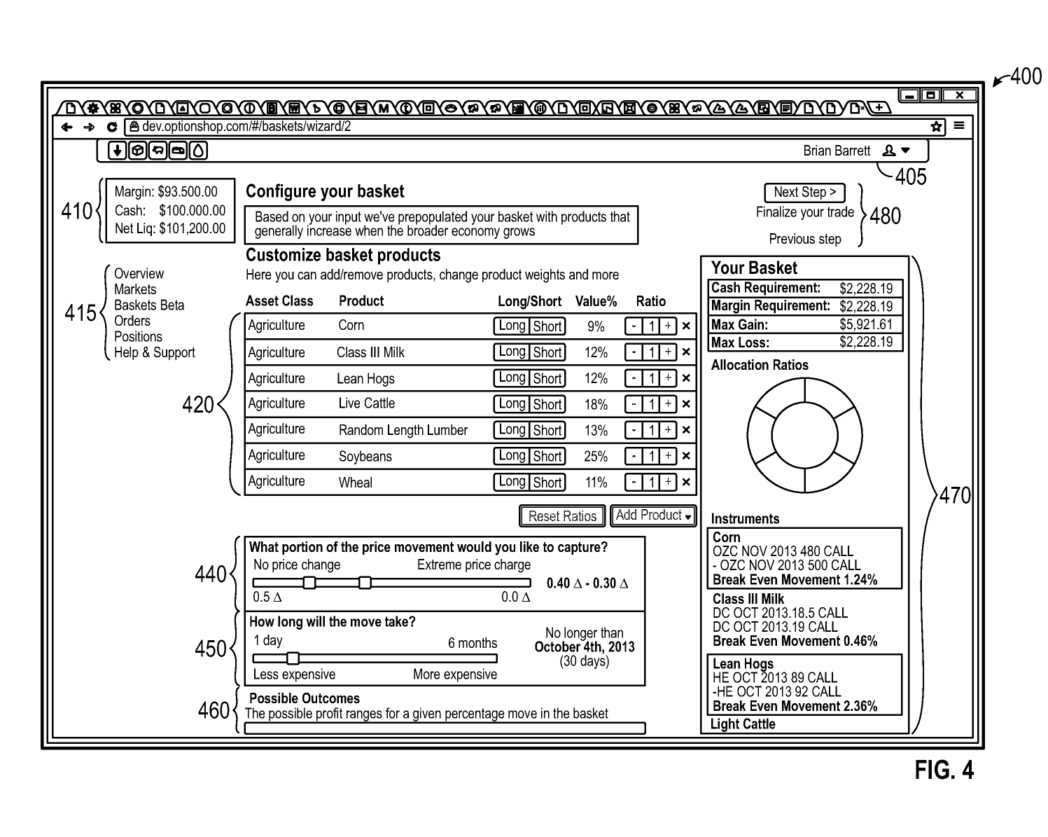

FIG. 4 illustrates an agricultural baskets page 400. The agricultural baskets page 400 is displayed when the trader activates the agricultural basket selection button 230 of the baskets menu page 200.

The agricultural baskets page 400 includes a trading account identifier and setup 405, a financial account summary 410, and a page menu 415 that operate similarly to those shown in FIG. 1.

Additionally, the agricultural baskets page 400 includes a basket product display 420. A delta double slider 440, a timing selector 450, a basket summary column 470, and a next step button 480 that operate similarly to those shown above in FIG. 3 and a chart of possible outcomes 460 similar to that shown in FIG. 8 below.

However, instead of six diversified asset classes, as shown in the basket product display of FIG. 3, the agricultural basket of FIG. 4 only includes products from the agricultural asset class as shown in the basket product display 420 of FIG. 4. More specifically, the basket product display 420 includes corn, Class III Milk, Lean Hogs, Live Cattle, Random length lumber, Soybeans, and Wheat as products, all of which are in the agricultural asset class.

The specific products shown in the basket product display may be selected in any of several ways. In a first embodiment, the products are predetermined and initially fixed—although products may be eliminated from the basket through the use of the product deletion button and/or added to the basket using the add product button. In a second embodiment, products meeting a predetermined liquidity threshold are included in the basket. In a third embodiment, a number of products to include may be predetermined or selected by a trader and the system may add that number of products to the basket in order of product liquidity. In another embodiment, the user may select whatever he wants to create a basket and make a completely custom basket.

Additionally, although FIG. 4 has been identified as an agricultural baskets page 400 and initially starts out with only agricultural products, the trader may use the add product button to add products from any asset class to the basket.

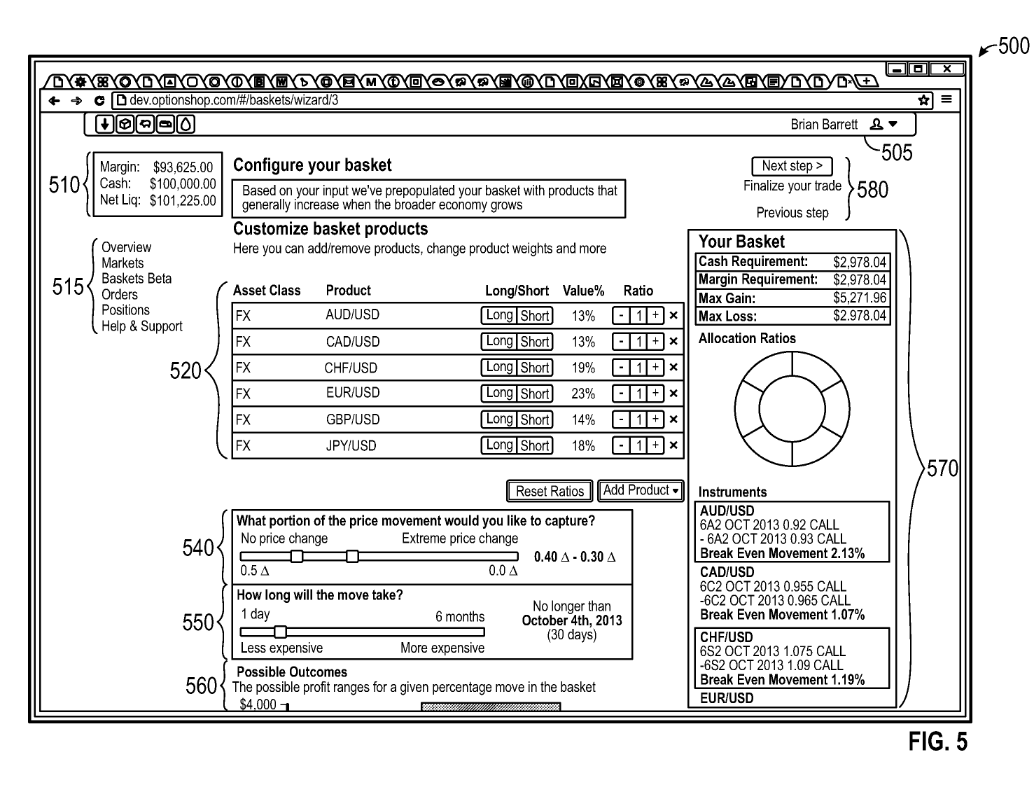

FIG. 5 illustrates an FX basket page 500, where FX is short for a foreign-exchange option or futures option or currency option or futures option. The FX basket page 500 is displayed when the trader activates the FX basket selection button 230 of the baskets menu page 200.

The FX baskets page 500 includes a trading account identifier and setup 505, a financial account summary 510, and a page menu 515 that operate similarly to those shown in FIG. 1.

Additionally, the FX basket page 500 includes a basket product display 520. A delta double slider 540, a timing selector 550, a basket summary column 570, and a next step button 580 that operate similarly to those shown above in FIG. 3 and a chart of possible outcomes 560 similar to that shown in FIG. 8 below.

However, instead of six diversified asset classes, as shown in the basket product display of FIG. 3, the FX basket of FIG. 5 only includes products from the FX asset class as shown in the basket product display 520 of FIG. 5. More specifically, the basket product display 520 includes, but is not limited to, an Australian/US dollar futures option spread, a Canadian/US dollar futures option spread, a Swiss Franc/US dollar futures option spread, a Euro/US dollar futures option spread, a British Pound/US dollar futures option spread, and a Japanese Yen/US dollar futures option spread, all of which are in the FX futures asset class.

The specific products shown in the basket product display may be selected in any of several ways. In a first embodiment, the products are predetermined and initially fixed—although products may be eliminated from the basket through the use of the product deletion button and/or added to the basket using the add product button. In a second embodiment, products meeting a predetermined liquidity threshold are included in the basket. In a third embodiment, a number of products to include may be predetermined or selected by a trader and the system may add that number of products to the basket in order of product liquidity.

Additionally, although FIG. 5 has been identified as an FX baskets page 500 and initially starts out with only FX baskets, the trader may use the add product button to add products from any asset class to the basket.

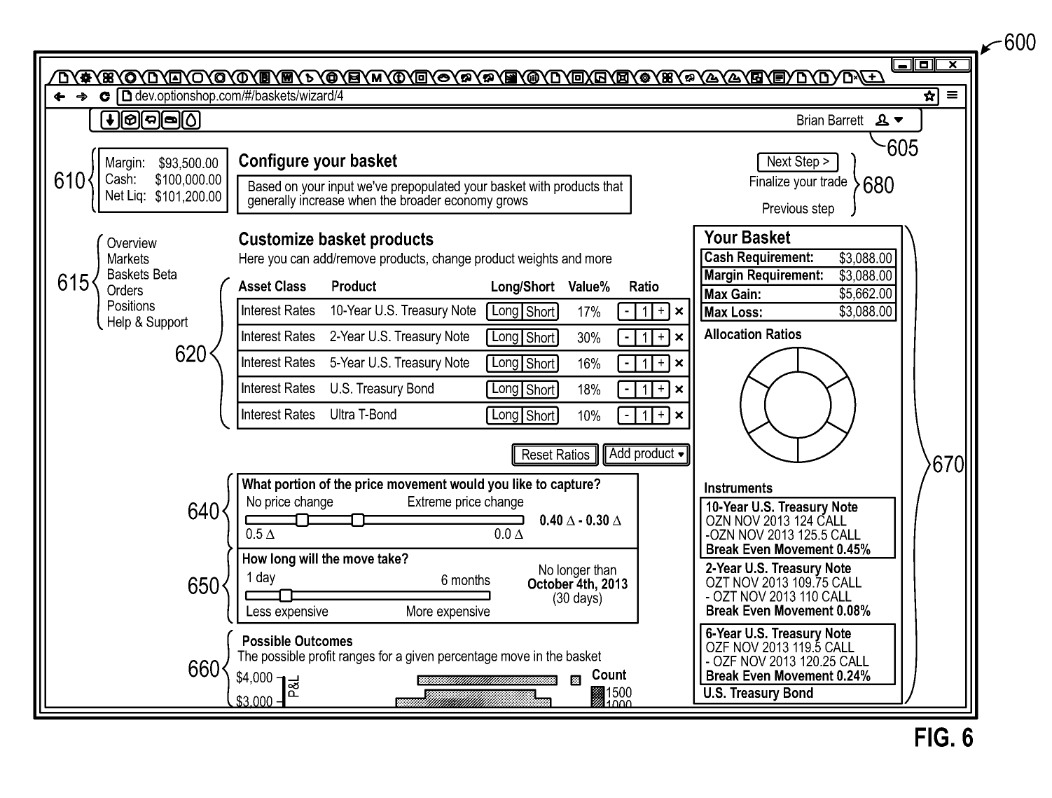

FIG. 6 illustrates an interest rate basket page 600. The interest rate basket page 600 is displayed when the trader activates the interest rate basket selection button 230 of the baskets menu page 200.

The interest rate basket page 600 includes a trading account identifier and setup 605, a financial account summary 610, and a page menu 615 that operate similarly to those shown in FIG. 1.

Additionally, the interest rate basket page 600 includes a basket product display 620. A delta double slider 640, a timing selector 650, a basket summary column 670, and a next step button 680 that operate similarly to those shown above in FIG. 3 and a chart of possible outcomes 660 similar to that shown in FIG. 8 below.

However, instead of six diversified asset classes, as shown in the basket product display of FIG. 3, the interest rate basket of FIG. 6 only includes products from the interest rate asset class as shown in the basket product display 620 of FIG. 6. More specifically, the basket product display 620 includes, but is not limited to, a 10-year US treasury note, a 2-year US treasury note, a 5-year US treasury note, a US Treasury Bond, and an Ultra T-Bond, all of which are in the interest rate asset class.

The specific products shown in the basket product display may be selected in any of several ways. In a first embodiment, the products are predetermined and initially fixed—although products may be eliminated from the basket through the use of the product deletion button and/or added to the basket using the add product button. In a second embodiment, products meeting a predetermined liquidity threshold are included in the basket. In a third embodiment, a number of products to include may be predetermined or selected by a trader and the system may add that number of products to the basket in order of product liquidity.

Additionally, although FIG. 6 has been identified as an interest rate basket page 600 and initially starts out with only interest rate products, the trader may use the add product button to add products from any asset class to the basket.

FIG. 7 illustrates the diversified baskets page 300 of FIG. 3 displaying the asset class selection menu when the add product button 334 has been pressed. As shown in FIG. 7, a drop-down menu with each of the asset classes is displayed.

Additionally, upon selection of an asset class, an additional drop-down menu displaying the products available in the asset class is displayed. Once the trader chooses both an asset class and a product, a new row is added to the basket product display 320 that shows the asset class, product, long/short, value percentage, ratio, and product deletion button, as with the other products.

FIG. 8 illustrates the chart of possible outcomes 360, as shown at the bottom of the web pages for the diversified basket, agricultural basket, FX basket, and interest rates basket. The chart of possible outcomes includes a vertical axis representing the profit and loss and a horizontal axis representing the aggregate percentage market move in products that make up the underlying basket. The profit ranges are calculated using a Monte-Carlo simulation and the chart itself is color or density plotted so that the most likely outcome profit ranges are shown based on the number of Monte-Carlo results appearing in that range.

FIG. 9 illustrates an alternative embodiment of the diversified basket webpage 300 of FIG. 3. As shown in FIG. 9, the delta double slider 340 has been altered so that the left delta selector 342 is set at 0.35 delta and the right delta selector 344 has been set all the way to the right at 0.0 delta. The current delta selection indicator 348 reflects this selection by only identifying the delta of the left delta selector 342.

Additionally, the basket instrument detail display 376, for each instrument, is shown to only include the purchase of a single instrument, and not the sale of another instrument. More specifically, because the right delta selector 344 is set all the way to the right, no future option is sold to offset the price of the future option that is purchased based on the positioning of the left delta selector 342.

FIG. 10 illustrates the finalize your trade webpage that is displayed when the trader activates the next step button 380, 480, 580, 680. FIG. 10 includes a trading account identifier and setup 1005, a financial account summary 1010, and a page menu 1015 that operate similarly to those shown in FIG. 1.

Additionally, FIG. 10 includes a trade instrument listing 1020, a basket value summary 1072 and a submit order button 1090. The basket value summary 1072 operates generally similarly to the basket value summary 372 of FIG. 3 and shows the cash requirement, margin requirement, maximum gain and maximum loss for the basket represented by the instruments shown in the trade instrument listing 1020.

The exemplary trade instrument listing 1020 shown in FIG. 10 represents the instruments selected by the trader in the diversified basket webpage of FIG. 9. For each instrument, the trade instrument listing 1020 shows a product identifier 1024, a quantity 1026, the instrument identifier 1028, a bid price 1030, an ask price 1032, and a cash requirement 1034.

Recall that in the embodiment of the diversified basket webpage of FIG. 9, the delta double slider 340 has been set to only purchase a futures option (or other instrument) and not to attempt to sell a corresponding instrument as shown in the other examples, such as in FIG. 3. Thus, although the trade instrument listing 1020 of FIG. 10 shows only a single instrument purchase for each product, a trade instrument listing showing the instruments to be traded for the exemplary diversified basket of FIG. 3 includes both the purchase of an instrument for a product and the sale of an instrument for a product. For example, as shown in the basket instrument detail display 376 of FIG. 3, the product of corn includes both the purchase of an OZC November 2013 480 CALL and a sale of the OZC November 2013 500 CALL both the sale and purchase would be shown in the trade instrument listing for FIG. 3.

Finally, once the trader is satisfied and wants to proceed with the transactions listed in the trade instrument listing 1020, the trader initiates the submit order button 1090.

Once the submit order button 1090 is initiated, the system checks to confirm that the trader is allowed to make the trades listed in the trade instrument listing 1020. In one embodiment, both the individual trades and the aggregate trade represented by the trade instrument listing are checked. The check may include margin requirements, cash requirements, SPAN requirements, contract limits, or restricted security requirements. In another embodiment, the system may prevent a user from trading a product where there in an abnormally large bid/ask spread, indicating a market aberration that would cause the customer to get filled at a disadvantageous price. The normality of the spread may be calculated using a historical standard deviation, and may be calculated relative to the bid/ask spreads of other nearby strike prices.

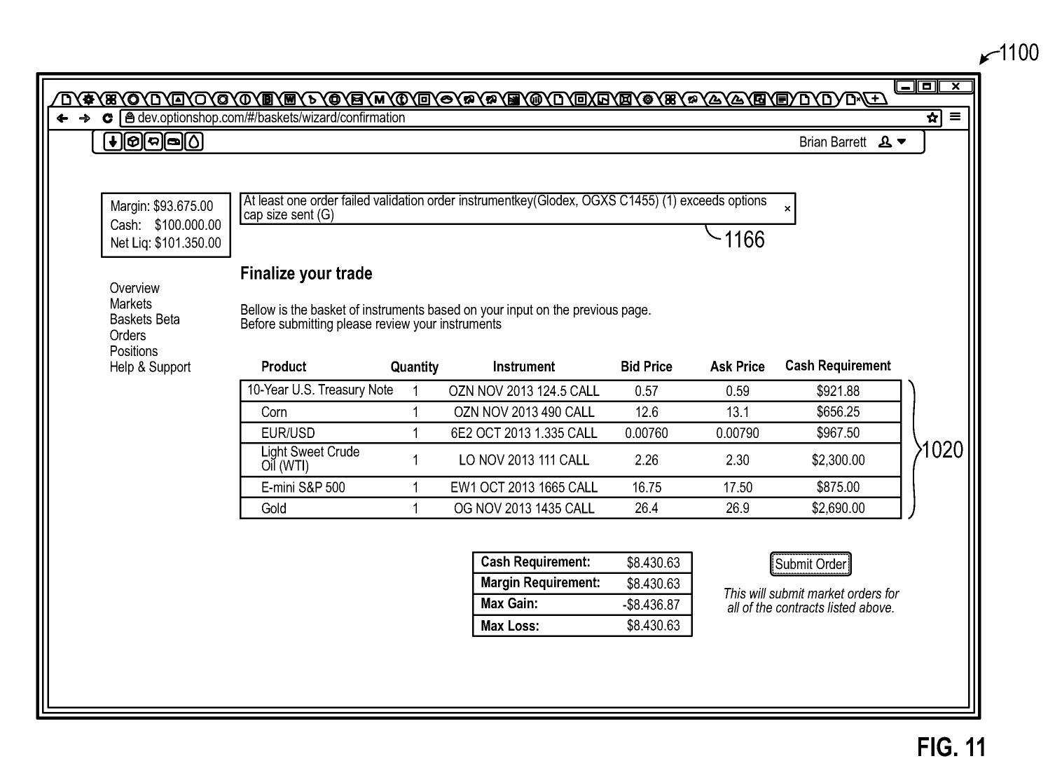

FIG. 11 illustrates the trade fail screen 1100. In FIG. 11, the trader activated the submit order button 1090 to attempt to initiated the trade, but the trade failed a requirement. More specifically, the trade fail screen 1100 includes a trade fail identifier 1166. In the example of FIG. 11, the trade fail identifier indicates that the trade failed because the option clip size limit was exceeded. A users “clip size” is the number of a particular product or contract that they can execute at a time. For example, a user with a clip size limit of “3” in the ES contract would not be able to trade more than 3 ES contracts at a time. An order to buy or sell 4 or more ES contracts would be rejected.

Once the trade fail screen 1100 has been displayed, the trader's proposed trade remains displayed in the trade instrument listing 1020, but the trader may return to the diversified basket webpage of FIG. 9 and modify one or more products. The trader may then finalize the modified trade and submit the modified trade for execution.

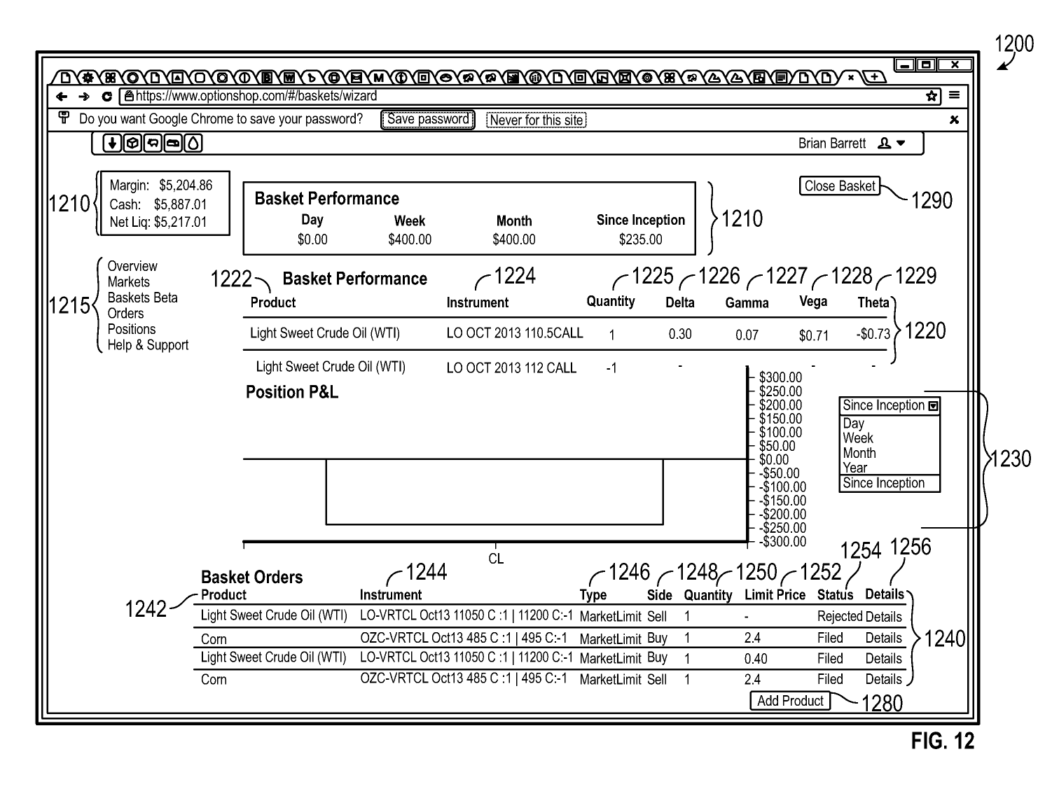

FIG. 12 illustrates a basket details page 1200. The basket details page 1200 may be displayed when the trader views FIG. 1 and activates the basket details button 130. The basket details page 1200 includes a trading account identifier and setup 1205, a financial account summary 1210, and a page menu 1215 that operate similarly to those shown in FIG. 1.

Additionally, the basket details page 1200 includes a basket performance summary 1210, a current basket positions listing 1220, a basket profit and loss 1230, and the instrument orders list 1240 that have taken place in the basket.

Thus, the basket details page 1200 allows a trader to track the performance of their basket in aggregate, as though it were single product or instrument, because the sum of the performance of each instrument in the basket is displayed to the trader in the basket performance window 1210.

Additionally, the trader may quickly view the current instruments in the basket in the current basket positions listing 1220. The current basket positions listing 1220 includes an identification of the product 1222 and instrument 1224, as well as the quantity 1225, delta 1226, gamma 1227, vega 1228, and theta 1229 for each instrument.

The basket profit and loss 1230 displays a chart of the profit and loss for the basket as a whole based on a time period, for example, a day, week, month, year, or since inception, as determined by the trader.

The basket orders list 1240 shows the instrument orders (both purchase and sale) that have been made using the current basket. The instrument orders 1240 include the product 1242, the instrument 1244, the type of order 1246, whether the order is to buy or sell the instrument (side) 1248, the quantity 1250, the limit price (if any) 1252, the status of the order 1254, and a details button 1256, which shows execution information for the specific order.

With regard to the instrument orders 1240, when the basket is first formed, the instrument orders list 1240 includes the initial purchase and/or sale of the instruments in the basket, such as the instruments that are displayed in the trade instrument listing 1020 of FIG. 10. However, one powerful element of the present system is that the contents of the basket may be changed and managed after the purchase of the initial instruments.

For example, considering the trade instrument listing 1020 of FIG. 10, if, when the trade activated the submit order button 1090, the trade was not rejected, the present system creates a new basket entry that is displayed on the introduction page 100. Upon activating the details button for that basket entry, the basket details page 120 is displayed. In the instrument orders list 1240 of the basket details page 1200 is shown the order for each instrument in the basket—thus all 6 instruments shown in the instrument identifier 1208 appear in the instrument orders list 1240.

However, at a later time, the trader may wish to change the instruments in the basket, for example by selling one or more of the instruments, purchasing one or more of the instruments, closing a position, or adding a new instrument to the basket. For example, if the basket includes the instrument of a vertical options spread in the corn product where the user had purchased the OZC October 13 485 call and sold the 495 call, the trader may activate the details button 1256 for the instrument. The details button 1256 brings up a screen displaying the details of the instrument and provides the trader with a trade button to allow them to sell the position. Alternatively, the trade interface allows the trader to purchase an additional quantity of the instrument.

Similarly, if the trader wants to add a new instrument to the basket, the trader may activate the add product button 1280. The add product button 1280 operates generally similarly to the add product button 334 of FIG. 3 and provides a series of drop down menus allowing the trader to select an asset class and product. Additionally, the add product button allows the trader to exit to general trade screen so that the trader may enter any trade they wish to include in the basket.

Finally, if the trader wants to close out the basket all at once, the trader may select the close basket button 1290 and the entire contents of the basket are bought or sold, depending on the open positions.

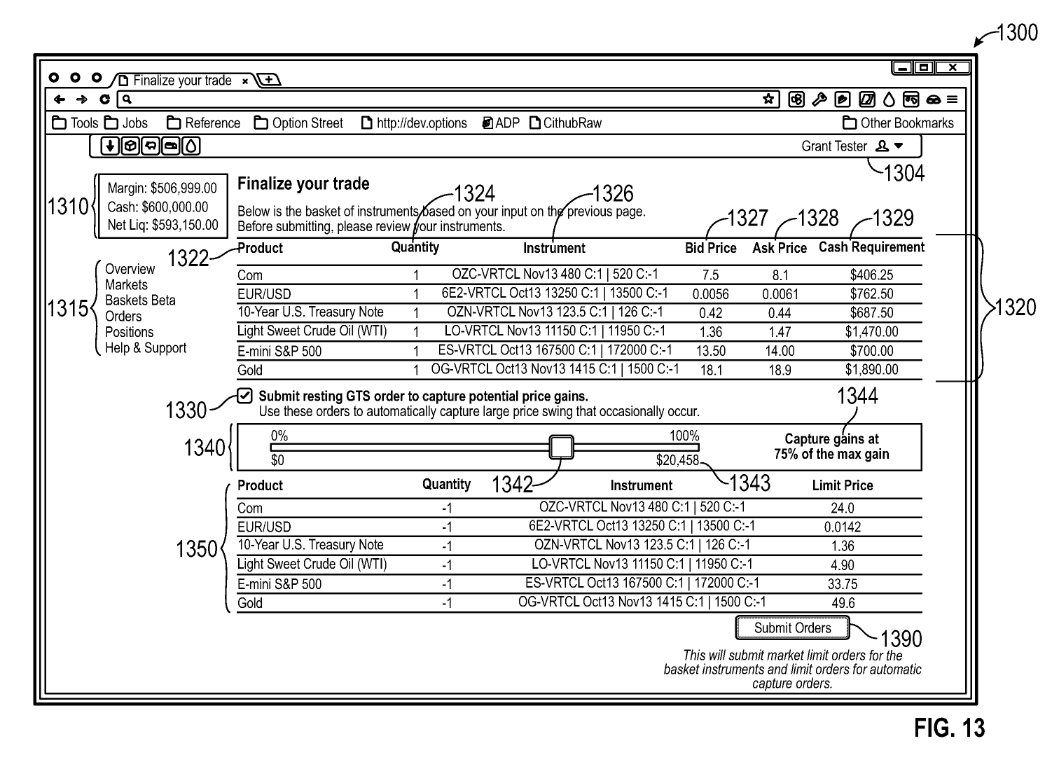

FIG. 13 illustrates an alternative finalize your trade webpage 1300 similar to that of FIG. 10 that is displayed when the trader activates the next step button 380, 480, 580, 680. FIG. 13 includes a trading account identifier and setup 1305, a financial account summary 1310, and a page menu 1315 that operate similarly to those shown in FIG. 1.

Additionally, the finalize your trade webpage 1300 includes a trade instrument listing 1320 generally similar to the trade instrument listing 1020 of FIG. 10, but with some changes. More specifically, the trade instrument listing 1320 includes the product 1322, quantity 1324, instrument 1326, bid price 1327, ask price 1328, and cash requirement 1329 for each instrument. Additionally, in the trade instrument listing 1320 of FIG. 13, the instruments being traded are vertical options trades that include the simultaneous purchase and sale of two options. For example, for the product corn, the instrument is a purchase of the OZC November 13 call at 480 and a simultaneous sale of the OZC November 13 call at 520.

In addition, the finalize your trade webpage 1300 includes a resting order submission selector 1330, a profit-take selector 1340, a resting order listing 1350, and a submit order button 1390.

When a trader activates the resting order submission selector 1330, the profit-take selector 1340 and resting order listing 1350 are displayed. In the profit-take selector 1340, the maximum gain for the basket is known because the basket is composed of vertical trades. For example, approaching expiration, gains in the corn product at some point beyond the 520 price point do not provide additional gains in the basket because the formation of the basket included selling a call at 520. Consequently, the maximum gain for the corn product is at the price point of 520. Similarly, the maximum gain for the basket may be found by determining the maximum gain for each instrument in the basket.

The maximum gain for the basket 1343 is displayed at the right of the slider 1342, and the slider may be positioned by the trader to select a point where the trader believes that he has extracted most of the value from the basket and desires to close the basket by selling all of the instruments in the basket. In the example shown in FIG. 13, the trader has positioned the slider at 75% of the max gain. The actual numeric value of the slider 1344 is also shown.

In other words, the top side of the scale shows a profit-take menu option for placing exit orders at a user chosen percentage of the maximum possible profit of the entire basket. The leftmost reading on the scale is set at 0% and the rightmost reading on the scale is set at 100%. The underside of the scale measures the dollar equivalents of those percentages on the top side. Thus, the dollar reading at the left most of the scale is $0.00 and the dollar reading at the right most of the scale is the maximum dollar profit minus the price paid for the basket, which the system refers to as ‘Max Gain’.

The resting order listing 1350 shows the trades needed to close out the entire basket, which is determines as follows. First, the system processes the dollar equivalent of each Basket component spread's chosen percentage of maximum possible profit and determines the prices those spreads would have to trade at to achieve those profits. It then displays and offers a menu button that places exit limit ‘Good-Till-Cancel’ orders for each component spread at those desired profit-taking price levels. As each spread is likely to not reach its maximum valuation concurrently with the other component spreads in a given basket, and as each spread may reach its maximum valuation at any time within any 23 plus hour trading day, the system attempts to ensure capturing the desired profit percentage on any given component spread in a basket whenever that profit opportunity may occur.

In one embodiment, if the user chooses a willingness to have resting exit orders in each of the component spreads at 75% of the ‘Max Gain’, then system calculates the dollar value of the difference between each of the spreads component strikes, subtracts the associated costs of each, which the system refers to as, ‘Cash Requirements’, for each, and then determines the minimum full tick representation for each spread to meet, or minimally exceed that user chosen % of ‘Max Profit’ requirement, and loads those specific spread prices as ‘GTC’ exit orders for the user to submit with the click of a ‘Submit Profit Exit Orders’ button. Whether entering or exiting a basket of trades, ‘Cash Requirement’ when buying a chosen call vertical refers to the current offer price on that spread. When selling, ‘Cash Requirement’ refers to the current bid price of that spread.

Thus, the Corn call vertical (OZC-VRTCL November 13 480 C:1 1 520 C: 1) that resulted from user defined inputs has a 40 cent difference in strikes which equates to $2000.00 given, in this example, Globex platform CBOT exchange contract specifications. $2000.00 minus trade cash requirement of $406.25 equals $1593.75 ‘Max Gain’. The system calculates 75% of that dollar figure to be $1195.31. That amount, divided by the contract defined $50.00/cent equals 23.9 cents. Per system design, that amount, rounded up to the nearest tradable unit, in this instance, equals 24.0 cents. This is the system price chosen for trade exit order of the user defined November 480-520 call spread

Continuing the example with the instruments shown in FIG. 13, current contract specifications, and the above system defined math for profit exit order generation results in the following exit orders for the remainder option spread contracts of this example basket:

Sell 1 EUR/USD call vertical (6E2-VRTCL October 13 1325.5 C: 1 1 13500 C: 1) at 142.

Sell 1 10-Yar U.S. Treasury Note call vertical (OZN-VRTCL November 13 123.5 C: 1 1 126 C: 1) at 1.36/64ths.

Sell 1 Light Sweet Crude Oil (WTI) call vertical (LO-VRTCL November 13 11150 C: 1 1 11950 C: 1) at 4.90.

Sell 1 E-mini S&P 500 call vertical (ES-VRTCL October 13 167500 C: 1 1 172000 C: 1) at 33.75.

Sell 1 Gold call vertical (OG-VRTCL November 13 1415 C: 1 1 1500 C: 1) at 49.60.

Additionally, the limit price shown for each instrument preferably varies in real time as the slider 1342 is repositioned by the trader. Once the trader is satisfied with the trade instrument listing 1320 and the resting order listing 1350, the trader actuates the submit orders button 1390 to initiate the trades in the instrument listing 1320 and establish the resting trades in the resting order listing 1350.

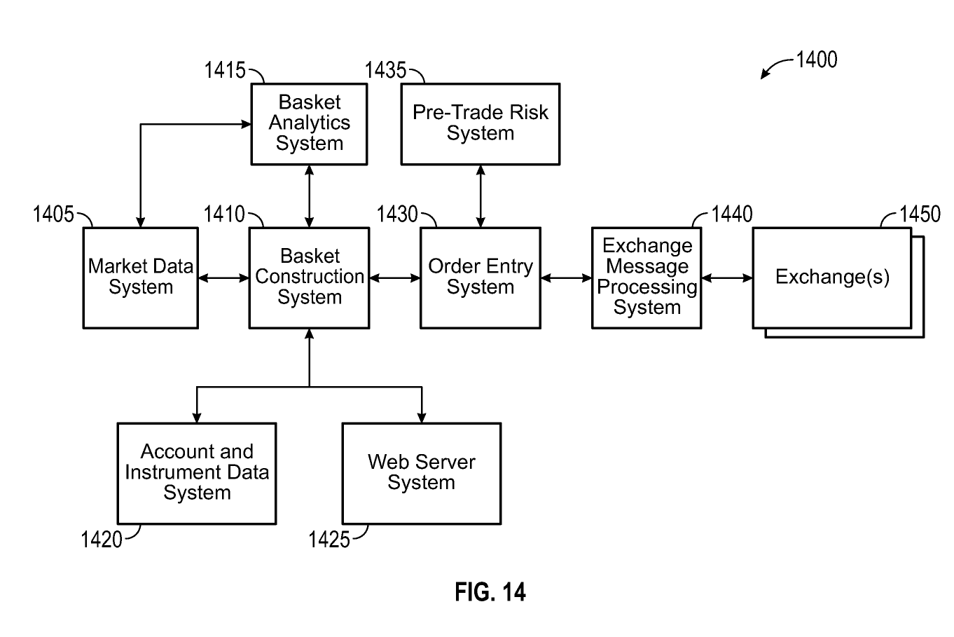

FIG. 14 is a system diagram illustrating the components of one embodiment of the present configurable portfolio basket trading system 1400. The configurable portfolio basket trading system includes a market data system 1405, a basket construction system 1410, a basket analytics system 1415, an account and instrument data system 1420, a web server system 1425, an order entry system 1430, a pre-trade risk system 1435, an exchange message processing system 1440, and one or more exchanges 1450.

In operation, a trader may gain access to the basket construction system 1410 by using the web server system 1425. More specifically, the web server system 1425 generates a web page requesting login information from the trader. The login information is received by the web server system 1425 and relayed to the basket construction system 1410. The basket construction system 1410 retrieves account information for the trader from the account and instrument data system 1420. If the right login information has been received, the basket construction system 1410 allows the trader's account information to be passed from the account and instrument data system 1420 to the web server system 1425, where it is viewable by the trader through a web application.

When the trader desires to make a trade, the web server system 1425 receives inputs to the pages it displays. Such inputs may be the selection of the new basket button 135 in the introduction page of FIG. 1, selection of a basket from the baskets selection menu 220 of FIG. 2, and the additional inputs specified above.

Further, the market data system 1405 passes market data to the basket construction system 1410 and the basket analytics system 1415. In one embodiment, the basket construction system 1410 uses the market data and the trader inputs from the web server system 1425 to determine the instruments to be traded, for example as listed in the basket instrument detail display 376.

The basket analytics system 1415 may determine basket analytics, such as running the Monte Carlo simulation shown in the chart of possible outcomes 360 of FIG. 8. The basket analytics system may provide the resulting analysis to the basket construction system 1410. The basket construction system 1410 may then relay the resulting analysis to the web server system 1425 for display to the trader.

As discussed above in FIG. 10, the trader eventually finalizes and submits the trade. At that point, the trade is passed from the basket construction system 1410 to the order entry system 1430. At the order entry system 1430, the proposed trade is reviewed by the pre-trade risk system 1435 which may check many requirements for the trade, such as margin requirements and cash requirements, for example. If the trade is not rejected by the pre-trade risk system 1435, then the order entry system 1430 passes the trade to the exchange message processing system 1440.

At the exchange message processing system 1440, the trade is processed for trading. For example, a trade including diverse asset classes may trade on several different exchanges. The exchange message processing system 1440 may separate the trades in the basket into their component trades and then pass them to the exchanges 1450 for execution.

Once the one or more exchanges 1450 have executed the trade, trade information is passed back from the exchanges to the exchange message processing system 1440. The exchange message processing system 1440 then assembles the trade information from the exchanges into the indicated basket and passes the trade information for the basket back to the basket construction system 1410.

The basket construction system 1410 may then display the executed trade information for the basket to the trader through the web server system 1425 and may store the executed trade information in the trader's account in the account and instrument data system 1420.

Returning now to the delta double slider, for example as shown in FIG. 3, the delta double slider may be considered a device for a user to exert an opinion on the likelihood of a range of price change in such a way that the system interprets the user chosen settings into either an outright option position or an option vertical spread. This is done through using a delta scale that ranges from a delta of 0.5 (At-the-Money) to an effective delta of 0.0 ((way) Out-of-Money), with the standard definition of delta being the rate of price change of a given option for every incremental change in its underlying cash or futures instrument applying.

If both sliders are engaged on the scale such that the right slider is not placed on the zero delta reading, then a spread trade is the system's processed output. The left slider defines the delta of the option closer to the money (or nearer to the market price of the underlying) intended for purchase and the right slider defines the delta of the further from the money option (or further from the market price of the underlying) intended for sale in what effectively will be an option spread trade defined as a ‘vertical’ option spread. The system processes these inputs and searches and displays the options (puts for bearish trades, and calls for bullish trades) closest to the user's chosen deltas. The full configurability of which allows user comparisons of various combinations of strike prices and their related cash outlays, max gains/losses ratios, and necessary price movements of the underlying instruments to achieve the option spreads' BEPs (break-even points).

The functionality whereby the user may choose an outright purchase of an option to exert his market prognostication is activated by way of the user's placement of the right slider on the 0.0 delta reading on the scale. The left slider then effectively chooses the delta, and, as above, the system processes and chooses the related option strikes that best fits the user's expectations of price movements of the underlying instruments, the cash outlay he is comfortable with, and other acceptable outputs such as margin requirement, if any, max gain/max loss ratio, and underling price movements necessary for each trade to break even.

Whether engaging either strategy, the space just to the right of the delta scale displays the delta value of the option to be purchased, and, if applicable, the delta value of the option strike to be sold against that intended purchase.

Thus, the system eliminates the heretofore traditional and taxing and time-consuming hunting of individual strikes to buy and/or individual strikes to sell in multiple markets in such a way as to have a balanced (by delta, and thus effectively by volatility (and by expiration)) basket of multiple trades across those multiple markets, especially in, but not limited to, non-standardized futures and futures options contracts. The system takes the user inputs and processes those general market opinions into specific outright options strikes or option spreads strikes as trades that the user may analyze from various parameters of costs and break-evens and payouts. In another embodiment of the delta double slider, the minimum delta would be calculated to be some number greater that “0.00” so as to ensure that the user was only placing order in liquid contracts. The system may identify that minimum delta by finding the strike price furthest from the money that still had a bid ask spread approximately equivalent to the nearest liquid strike, identifying the delta of that strike, and making that the minimum.

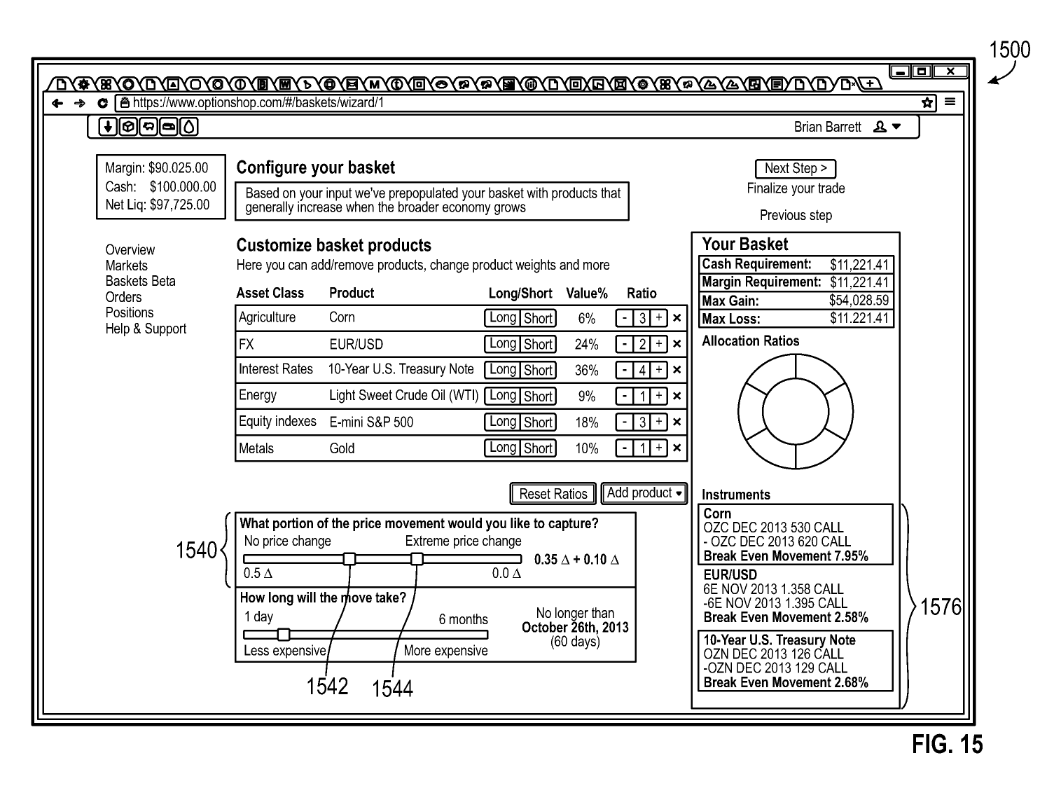

FIG. 15 illustrates a diversified baskets page 1500 with a delta double slider 1540 having a left delta selector 1542 with settings of buying 0.3 deltas and a right delta selector 1544 with settings of selling 0.1 deltas in a series of theme trade related user defined, system processed vertical option spreads. The system displays output of those precise option spread trades in the basket instrument detail display 1576.

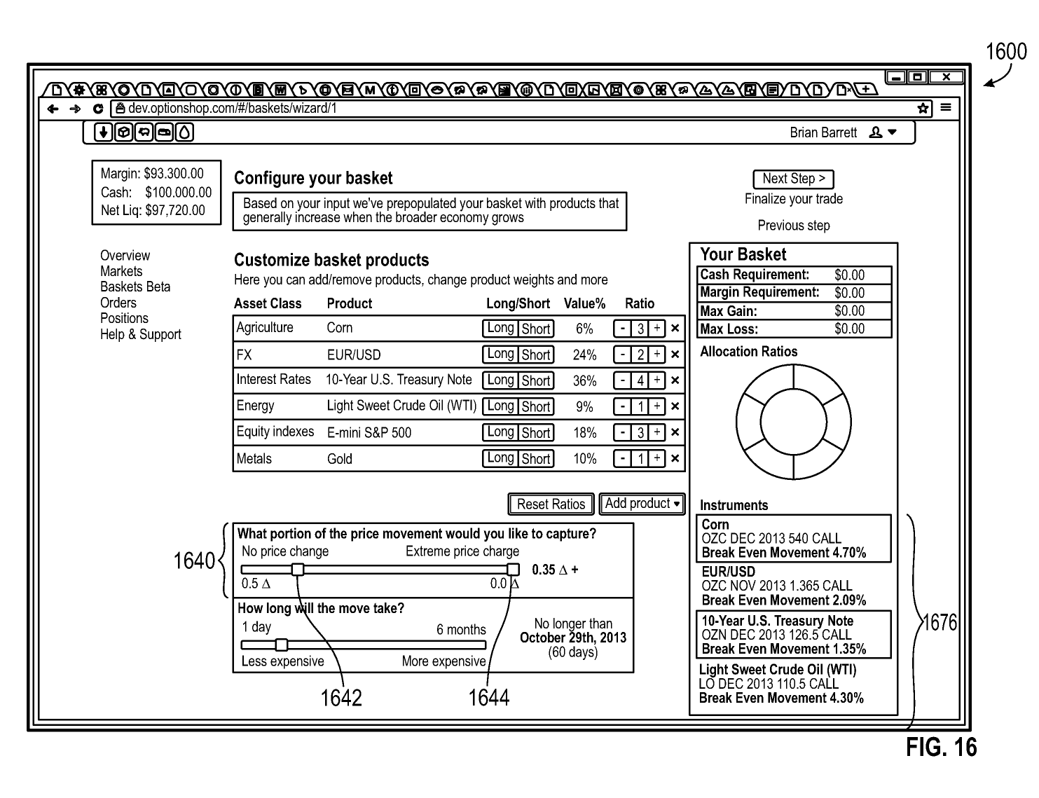

FIG. 16 illustrates a diversified baskets page 1600 with a delta double slider 1640 having a left delta selector 1642 with settings of buying 0.35 deltas and a right delta selector 1644 that has been disengaged by the user so that the user has instructed the system to perform outright option trades. Again, the system displays output of those precise option spread trades in the basket instrument detail display 1676.

Further, the system preferably updates the basket instrument detail display 1676 in real time as the trader slides the slider. More specifically, as the delta selected by the trader changes, the system may automatically recalculate the instrument that conforms to the presently selected delta and display it in the basket instrument detail display 1676.

In another embodiment of the system, the trader may establish a 401K/IRA Basket. For example, first the system may allow the trader may pick debt component product(s) and/or equity component product(s) to be included in his 401K/IRA Basket. Next, the trader may then pick the predicted directionality of his debt and equity components. For example, if the trader wants to enhance the return of their 401K/IRA, they may select “Enhancement” which may provide long trading instruments. Conversely, if the trader wants to mitigate risk in their 401K/IRA, then the trader may select “Hedge” which may provide short trading instruments.

The system may then display chosen products and their notional dollar tallies and their percentage make-ups by products and by sectors. Next, the system may offer a menu choice for diversifying products (for example, currency futures, metals, energies, grains, softs) to be included in 401K/IRA Basket. The trader may then select products, quantities and directions as generally discussed above. Next, the system may show adjusted tallies of notional dollars and percentage make-ups of products and sectors within Basket.

The trader may continue to mix and match products and quantities until satisfied with type and percentage allocations. The system may then offer menu choices of how to be ‘long’ or ‘short’ component instruments, including, but not limited to: futures, options, option spreads, futures options, and futures options spreads. Further, the system may provide full configurability with regard to number of contracts, spread ratios, and their directionality, and whether option premium is to be bought or sold. Additionally, the system may display contract months that correspond to users chosen input of expected holding period time horizon. Also, the system may include slider functionality such that if the trader picks futures options or futures option spreads, the system displays current market dollar outlays of the trader's chosen combinations of strikes (and their deltas) to be bought and sold, or sold and bought and their tallies of margin, maximum gain, and maximum loss.

One or more embodiments of the present system may be implemented on one or more of the following exchanges: NYSE, NASDAQ, Tokyo Stock Exchange, London Stock Exchange, Euronext, Hong Kong Stock Exchange, Shanghai Stock Exchange, Toronto Stock Exchange, Frankfurt Stock Exchange, Australian Securities Exchange, Bombay Stock Exchange, National Stock Exchange of India, SIX Swiss Exchange, BM&F Bovespa, Korea Exchange, Shenzhen Stock Exchange, BME Spanish Exchanges, JSE Limited, Moscow Exchange, Singapore Exchange, Taiwan Stock Exchange, Multi Commodity Exchange of India, Thailand Futures Exchange (TFEX), BM&FBOVESPA, Warsaw Stock Exchange, Hong Kong Exchanges, Australian Securities Exchange (incl. SFE), Osaka Stock Exchange, Korea Exchange, Montreal Exchange, Athens Derivatives Exchange, NYSE Liffe (European markets), Chicago Board Options Exchange (CBOE), Tokyo Stock Exchange Group, Eurex, TAIFEX, MexDer, ICE Futures U.S., Tel-Aviv Stock Exchange, Bombay Stock Exchange, International Securities Exchange (ISE), NASDAQ OMX Nordic Exchanges, Wiener Börse, CME Group, Johannesburg Stock Exchange, Borsa Italiana, NASDAQ OMX PHLX, MEFF, Singapore Exchange, NYSE Amex, Oslo Børs, Dalian Commodity Exchange, Intercontinental Exchange, Zhengzhou Commodity Exchange, Shanghai Futures, Exchange, ASX Group, BSE India, TMX Group, Osaka Securities Exchange, London Metal Exchange, Taiwan Futures Exchange, JSE South Africa, BATS Exchange, Hong Kong Exchanges and Clearing, China Financial Futures Exchange, Singapore Exchange, Tokyo Financial Exchange, Turkish Derivatives Exchange, and MEFF.

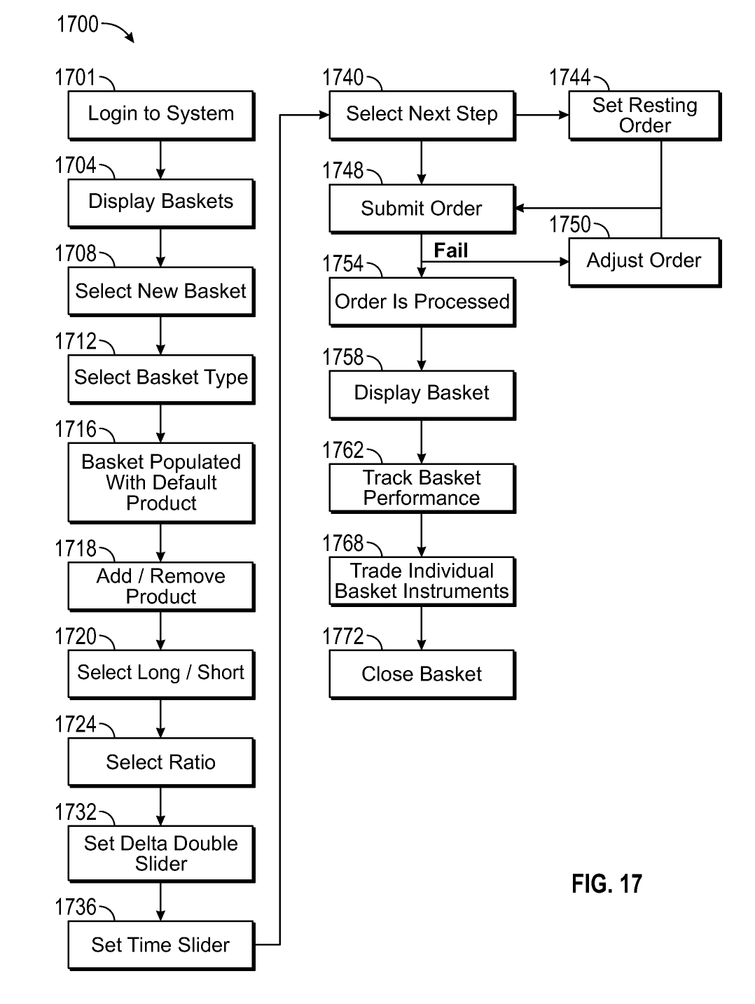

FIG. 17 illustrates a flowchart 1700 of an embodiment of the present system. First, at step 1701, a trader logs in to the system. Next, at step 1704, the trader is presented with an introduction page where the trader may see the baskets that have already been established. Next, at step 1708, the trader selects the new baskets button to begin the establishment of a new basket. Then, at step 1712, the baskets menu is displayed and the trader selects a basket type from the baskets menu.

At step 1716, the selected basket is populated with the default asset classes and products as described above. Further, at step 1718, the trader may add one or more additional products to the basket or remove one or more products from the basket. Next, at step 1720, the trader may change the settings for each product from its default setting as long to a short setting. Then, at step 1724, the trader may adjust the ratio of the products relative to each other away from their default 1:1 ratio if desired.

At step 1732, the trader sets the double delta slider as discussed above. Next, at step 1736, the trader sets the time slider. Then, once the trader is satisfied with the contents of the basket, the trader selects the next step button at step 1740.

Optionally, the trader may choose to establish a resting order at step 1744. As discussed above, the resting order may be set at a percentage of the expected profit chosen by the trader and may automatically sell one or more products in the basket when the product reaches the expected profit.

Next, the trader submits the order at step 1748. The order is analyzed with regard to several requirements including cash and margin requirements and if the order fails any of the requirements, then the trader is given the opportunity to adjust the order at step 1750.

Then, at step 1754, the order is processed by actually performing the trades included in the order. Trade confirmation is then received and displayed to the trader at step 1758.

The trader may then track the performance of the basket at step 1762. At some point in the future, the trader may desire to manage the basket by trading individual basket instruments at step 1768, for example by selling one or more basket instruments or purchasing new instruments for inclusion in the basket. Finally, the trader will close out the basket at step 1772 and all of the instruments in the basket are sold.

Thus, the present system addresses the trading and investment communities' needs for a new, low-cost, easy to assemble, self-executed vehicle (within, but not limited to, for instance, a futures account as part of a self-directed IRA), in part, for introducing commodities as a viable alternative investment asset class. These customizable (with regard to sector groupings, contract types, quantities, weightings, expirations, expected percentage price changes over expected holding periods), multi-contract products add diversification to standard components of portfolio construction without the high fees and/or significant flaws that accompany current indexed ETF, resource stock, hedge fund, or managed futures products. Beyond futures, and futures options, the present system's assemblage methodology, the computational functionality, and the presentation programming included may be applied to any and all actively traded asset classes, for example, stock and stock options and stock option spreads, foreign exchange and foreign exchange options and foreign exchange option spreads, swaps and swap options and swap option spreads, for purposes of assembling an investment or speculative theme trades, incorporating concept aspects of price changes assumptions and volatility changes assumptions over time horizons.

With basket component instrument choices, initially defaulted to most liquid contracts within their defined sectors, yet remaining completely configurable, including, but not limited to, commodity and/or financial futures products, either as outright futures, or outright futures options, or futures options spreads, or any combination of the three, grouped by investment or strategy themes, these new tradable financial products and new processes allow users to position themselves either long or short or market neutral for hedging or speculative purposes, in multi-contract trade strategies that relate to an overall ‘theme’ trade, herein referred to as a basket. Users may customize, as one of several possible examples, a themed portfolio to attempt to capture the general price appreciation or depreciation associated with an up-tick, or down-tick in overall economic activity. These baskets are unique in their menu methods of composition, the computational methodologies of their weighting options, their programming assemblage processes, and their display and tracking methodologies.

In one or more embodiments, the present system provides default functionality whereby the system searches and loads and displays most liquid contracts within each identified sector, weighs, by equal number of contracts, by least common multiple of dollar amount of notional value, or by volatility, in one instance, in the form of exchange derived span margining, again using a least common multiple approach as delineated herein. Such novel responsiveness with regard to basket construction allows users to balance component representation in relation to actual current relative price action. This novel system subsequently loads as a default, yet configurable setting, ratio futures option spreads (where quantity of long closer-to-the-money options is either greater than or less than, or equal to the quantity of short further-out-of money options) and matches options' expirations and strikes to a user's chosen expected basket price appreciation/depreciation, based on their selections with the delta double slider, over user's chosen expected time frame. The user also has the option of adjusting the holding period by a program menu choice of electing a strategy exit date that leaves at least 14 days left to expiration of the closest expiring option month within the comprised basket so as to take advantage of optimizing the difference in the time decay curves of At-the-Money and Out-of-Money options as they approach expiration. (Options closer to ‘the-Money’ decay at a slower rate than options further from ‘the-Money’, up until approximately 2 weeks left to expiration.) These spreads are further customizable to user's chosen future volatility assumptions that are configurable, with a default setting of an increase (when applicable), which allows for an open-ended profitability over those chosen time frames. Each directionally biased basket also offers configurable ‘financing’ in the form of selling opposite futures options, or opposite futures options spreads (in a default ratio setting of 1:1) as a way of lessening any particular strategy basket's initial cash outlay. For instance; if a basket has, as its assumption, an appreciation in price of the underlying commodities, in the default setting form, would be comprised of long ratio futures option call spreads, and short non-ratio (1 to 1) futures options put spreads.

In one embodiment, the system provides optional add-on strategy displays, in the format of a spreadsheet, financing options, including shorting opposite direction options, for example, if a long call strategy, then configurable financing choices include the shorting of puts or the shorting of put spreads, and if long puts strategy, then configurable financing choices include the shorting of calls or the shorting of call spreads. The tally rows of the fully configured strategy spreadsheet conveys to the user the system's processing of various maximum gains, maximum losses, the percentage overall movements in the specific array of basket strategies required to reach their break-even levels, their margin requirements, and their cash requirements.

These unique, defaulted yet configurable spreadsheets allow a general basket investment theme to be tweaked to users' preferences of overall risk/return characteristics. The system's novel programming and display methodologies operate to get readily comparable figures in front of the user which saves the prohibitive time expenditures of hunting and pecking and computing and executing of each possible basket component heretofore necessary to attempt such an assemblage of relevant data into a portfolio theme trade.

The currently necessary steps in attempting to mimic this unique, strategic composition would produce ineffectual, dated and unreliable data that could not be acted upon within a known risk parameter. The baskets' bids/asks display the dollar value of potential premiums received/premiums paid. Once the actionable components are assembled, visualized, and contemplated, a user simply selects his customized basket that best fits his risk tolerance, and double clicks on the novel default, ‘Execute Basket’ button, to send and confirm the requisite multiple market orders to the exchange for trade execution. Further optionality allows the user to join all component bids as a buyer, or join all component offers as a seller, or split every component bid/ask, as either a buyer or seller, all at the user accepted risk of missing all or part of the particular multi-contract strategy executions.

In one embodiment, the system provides Single-Click order entry and execution functionality of either multiple futures contracts, multiple futures options contracts, or multiple futures options spreads contracts as program reads individual contract bid/ask spreads and places multiple orders in multiple markets. The system searches, tallies and presents a display functionality whereby underlying contracts' dollar value of bid or offer sides (if selling or buying respectively), while showing un-weighted or weighted tallies of futures quantities and related margin requirements, or futures options or futures options spreads quantities and related premiums for proposed multi-legged trade and allows user to process and compare risk parameters of various component combinations; including either futures, futures options (ATMs through defaulted yet configurable OTMs), or futures options spreads (ATMs-OTMs, OTMs-OTMs, defaulted yet configurable) and either hit all subcomponent bids, or lift all subcomponent offers, or join or split bids and/or asks as described above.

The auto-loading of multiple basket components, whereby a user's expected price move, expected holding time, and chosen weighting techniques, are processed into quantities, ratios, contract months, options strikes, and options expiration months that ‘best fits’ all stated strategy requirements, along with the one-click ability to transact the basket as one group of trades, as though it were a single product, defined by an investment theme, represent industry product novelty. The program's resultant ease of basket assemblage, with or without financing options, makes available timely strategies that would otherwise be unavailable to the trading community by having to hunt and peck all the component parts together by himself.

Again, in a preferred embodiment, the system provides a tabular visual display for comparison of the choices of strategy instruments, and, as differentiated from standard indices, the aggregated pricing of any one Basket, comprised, for instance, of several futures options spreads, as a single priced product is unique to the exchange traded products industry. Other fundamentally novel processing functionalities include the visual display of the tracking of these baskets as single price products (as though it were a single security) whereby the aggregated trade entry price is defaulted shown as “$0”, thereby showing prices greater than $0 when the basket is, on the whole, profitable, and prices less than zero when the basket is, on the whole, losing money, based on current market movements. Functionality to one-click exit at any time from the menu option or from the customize running P&L chart, or from the Open-Orders section of the system platform represent unique functionalities for these new strategy tools.

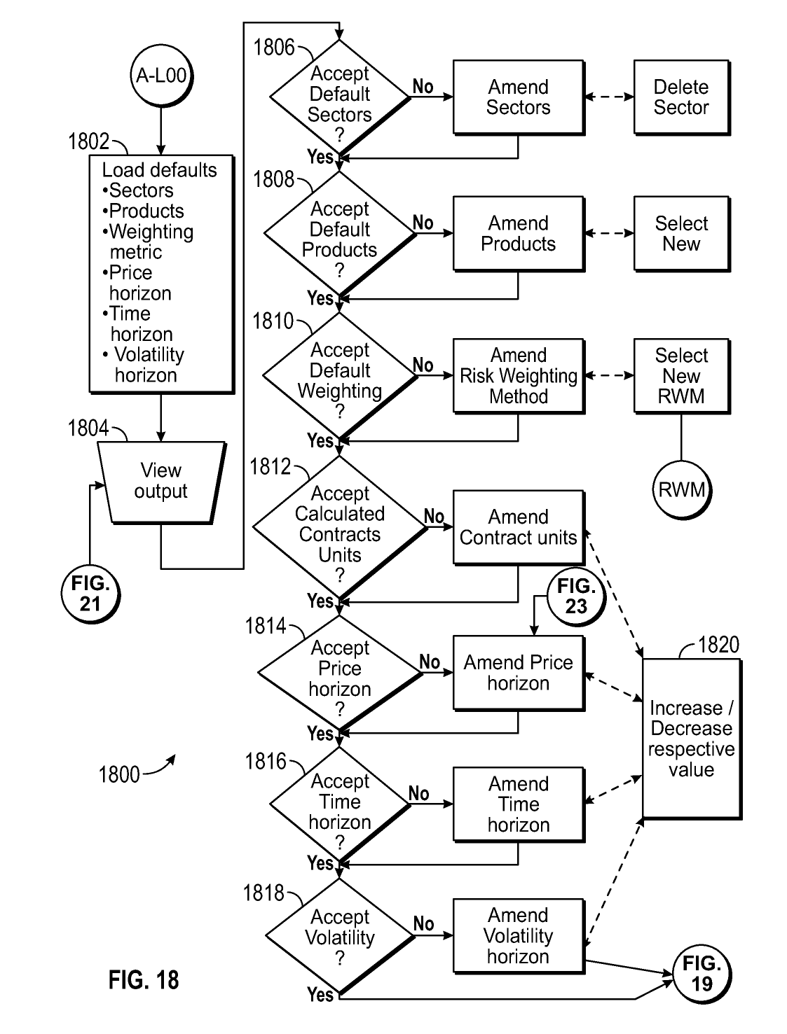

FIGS. 18-21 illustrate and alternative embodiment of the configurable portfolio basket trading system. More specifically, FIG. 18 illustrates a flowchart 1800 of the setup of the configurable portfolio basket trading system. First, at step 1802 the defaults are loaded into the system. The defaults include sectors, products, one or more weighting metrics, one or more price horizons, one or more time horizons, and one or more volatility horizons. Next, at step 1804, the horizons and at least one configurable portfolio basket may be viewed by a trader.

At step 1806, the trader determines whether the default sectors are acceptable. If not, the sectors are amended, added, and/or deleted. At step 1808, the trader determines whether the default products are acceptable. If not, the products are amended, added, and/or deleted. At step 1810, the trader determines whether the default risk weighting method is acceptable. If not, a new risk weighting method is selected.

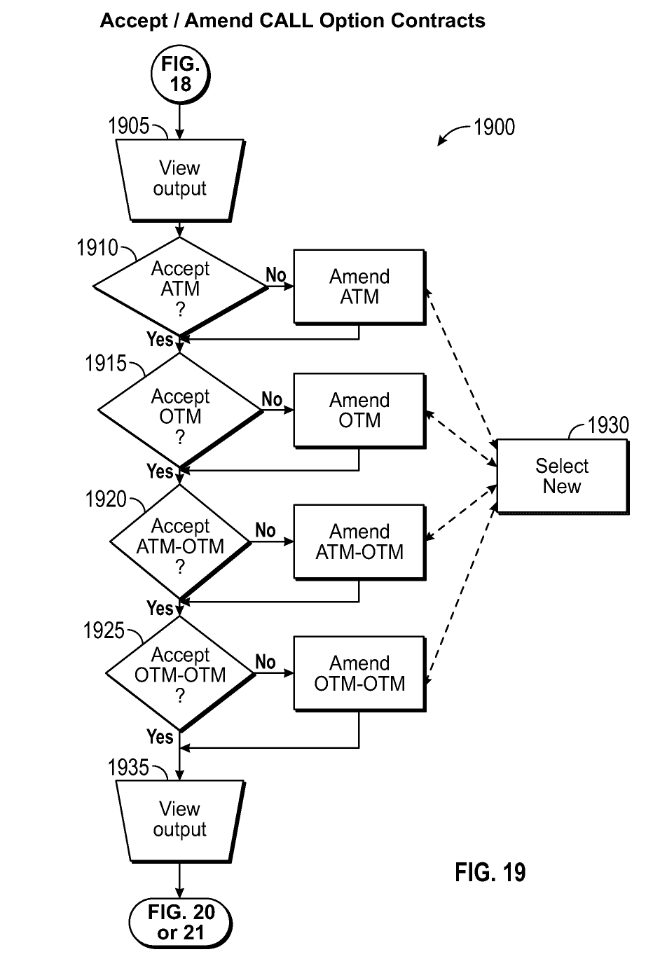

At step 1812, the trader determines whether the calculated contracts units are acceptable. If not, the contracts units are mended. At step 1814, the trader determines whether the price horizon is acceptable. If not, the price horizon is amended. At step 1816, the trader determines whether the time horizon is acceptable. If not the time horizon is amended. At step 1818, the trader determines whether the volatility is acceptable. If not, the volatility is amended. If changes are made to any of steps 1812, 1814, 1816, or 1818, then the flowchart proceeds to step 1820 where the respective values are increased or decreased. The flowchart then proceeds to FIG. 19.

FIG. 19 illustrates a flowchart 1900 of accepting or amending call option contracts as part of the present system. First, at step 1905, the results of the flowchart of FIG. 18 are displayed to the trader. Next, at step 1910, the trader determines whether the At-The-Money (ATM) call options are acceptable. If not, the ATM options are amended. Next, at step 1915, the trader determines whether the Out-Of-The-Money (OTM) call options are acceptable. If not, the OTM options are amended. Next, at step 1920, the trader determines whether the ATM-OTM options are acceptable. If not, the ATM-OTM options are amended. Next, at step 1925, the trader determines whether the OTM-OTM options are acceptable. If not, the OTM-OTM options are amended.

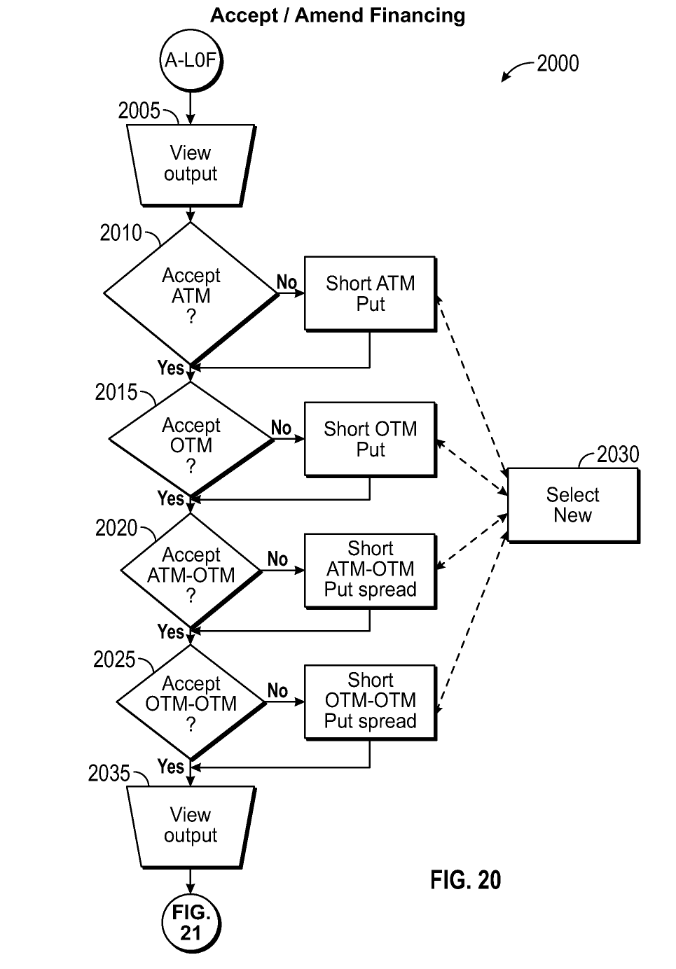

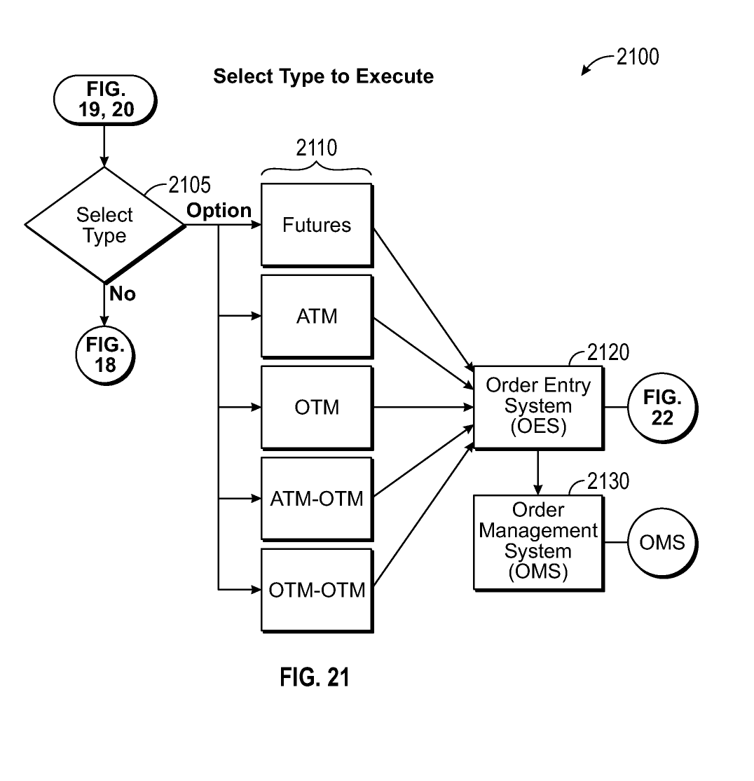

Additionally, at step 1930, new ATM, OTM, ATM-OTM and/or OTM-OTM options may be selected by the trader. Then, at step 1935, the trader's selections and the current basket may be viewed. The process then proceeds to FIG. 20 if the trader desires to implement trades to finance the basket or directly to FIG. 21 if no financing is desired.

FIG. 20 illustrates a flowchart 2000 of accepting or amending financing for trading the basket. First, at step 2005, the results of the flowchart of FIG. 19 are displayed to the trader, including an indication of the cash and margin cost of implementing the basket. Next, at step 2010, the trader determines whether the ATM cost is acceptable. If not, the trader proceeds to short one or more ATM puts. Then, at step 2015, the trader determines whether the OTM cost is acceptable. If not, the trader proceeds to short one or more OTM puts. Then, at step 2020, the trader determines whether the ATM-OTM cost is acceptable. If not, the trader proceeds to short the ATM-OTM put spread. Then, at step 2025, the trader determines whether the OTM-OTM cost is acceptable. If not, the trade proceeds to short the OTM-OTM put spread. Additionally, at step 2030, any new ATM puts, OTM puts, ATM-OTM spreads, or OTM-OTM spreads desired by the trader may be added to the basket. Finally, at step 2035, the revised basket including all proposed trades is displayed to the trader. The process then proceeds to FIG. 21.

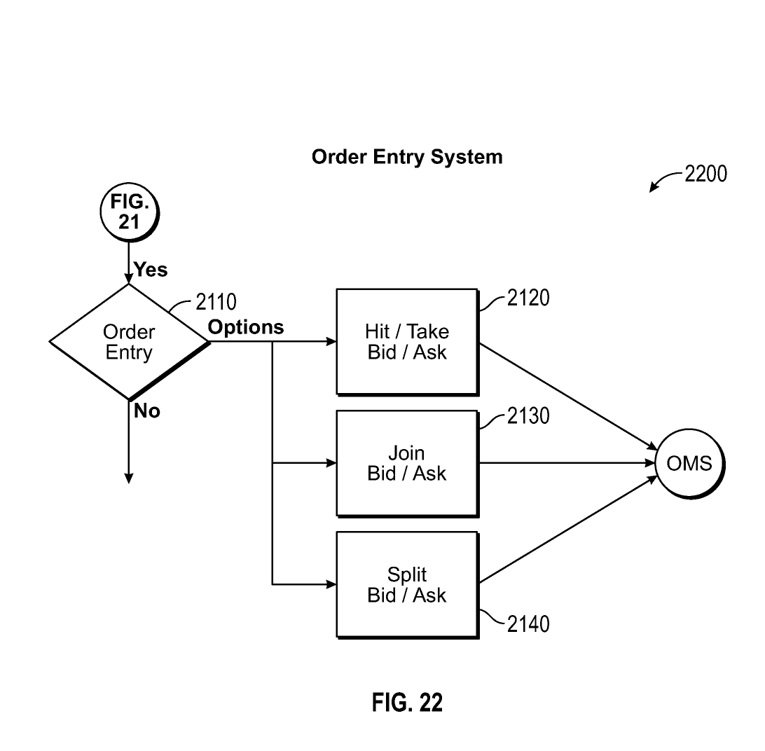

FIG. 21 illustrates a flowchart 2100 of selecting the instrument type to execute and entering a trading order. First, at step 2105, the trader selects the type of instrument to trade from among the trading instruments 2110 listed. The trader may select one or more of the trading instruments based on the trades in the basket. The selected trades are then passed to an order entry system at step 2120. The order entry system is further discussed in FIG. 22. After the order entry system, the flowchart proceeds to the order management system at step 2130 and the trade is executed.

FIG. 22 illustrates a flowchart 2200 of an order entry system. The process proceeds from FIG. 21 and at step 2110, the trade indicates that an order entry is desired. Then, the system receives the options portion of the basket. At step 2120, the process determines the Hit/Take Bid/Ask for the desired option trade for the basket and/or a portion of the basket. At step 2130, the process determines the Join Bid/Ask for the desired option trade for the basket and/or a portion of the basket. At step 2140, the process determines the Split Bid/Ask for the desired option trade for the basket and/or a portion of the basket. The process then determines the most cost effective way to implement the desired trade using any of Hit/Take, Join, and/or Split, and passes the desired trade to the order management system for execution.

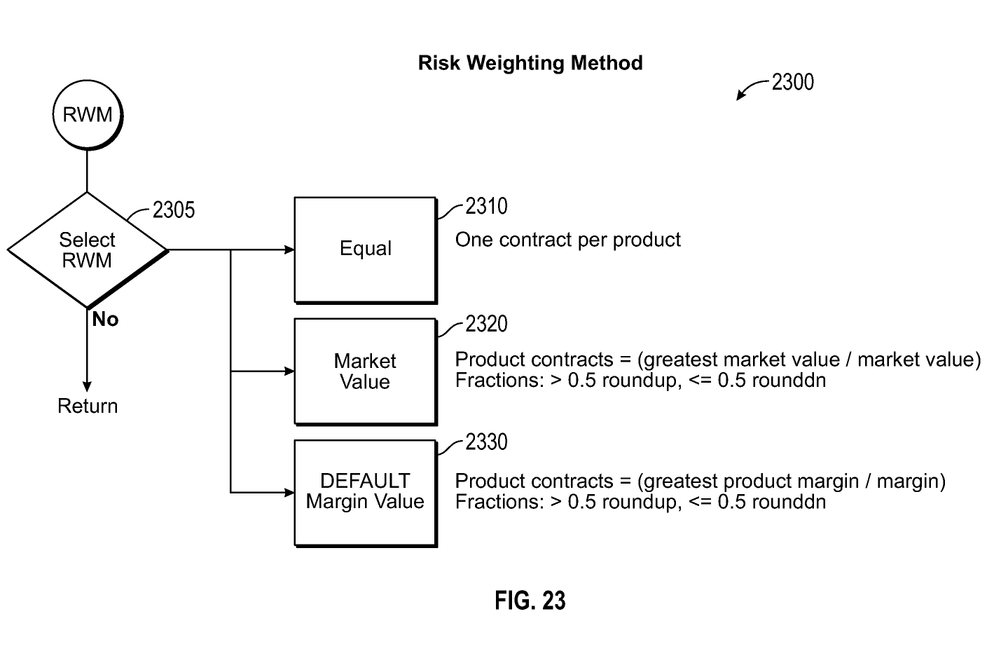

FIG. 23 illustrates a flowchart 2300 of the process of weighting risk across a basket according to one embodiment of the invention. As shown in FIG. 23, the trader may select a risk weighting method. For example, the risk weighting method may be selected by the trader my activating the reset ratios button 332 of FIG. 3. In one embodiment, activating the rest ratios button 332 brings up a drop down menu that allows the trader to select one of three risk weightings for the products in the basket.

At step 2310, the trader selects the equal risk weighting which applies one contract per product as shown in FIG. 3. Alternatively, at step 2320, the trader selects the market value risk weighting. The market value risk weighting determines the number of contracts for a specific product by taking maximum market value in the basket and dividing it by the market value of the specific product. When the division produces a fraction, remainders greater than 0.5 result in the number of contracts for that product being rounded up and remainders less than or equal to 0.5 result in the number of contracts for that product being rounded down.

Alternatively, at step 2330, the trader selects the default margin value weighting. The margin value risk weighting determines the number of contracts for a specific product by taking maximum product margin value in the basket and dividing it by the margin value of the specific product. When the division produces a fraction, remainders greater than 0.5 result in the number of contracts for that product being rounded up and remainders less than or equal to 0.5 result in the number of contracts for that product being rounded down.

In one or more embodiments, the present system provides the following: Selecting group of instruments by the delta, Selecting group of instruments based on volatility assumptions, Selecting group of instruments based on price movement assumptions, Selecting group of instruments by the days until expiration (includes 14 day), Selecting a ratio of products by equal notional value (such as least common multiple or rounding to nearest $10,000), Selecting a ratio of products by equal margin value, Selecting a ratio of products by basket purpose (for example IRA selection may be 60% stock and 40% bonds), Displaying products choices by market liquidity, Submitting orders to realize gains at a default or user defined threshold, Manually setting a ratio of products to be included in the basket, Creating a basket of long and/or short products, Displaying a distribution of potential payoffs based on a group of instruments performance, Displaying multiple trading strategies for comparing risk characteristics, Single click execution of multiple exchange orders, Automatic pre-trade RFQ of orders, Displaying pre-made groups of baskets, Performing pre-submission risk checks on multiple concurrent orders, Tracking multiple orders as component parts of a single basket, Tracking multiple positions as component parts of a single basket, Displaying the aggregate P&L and risk characteristics of a user defined group of instrument, Displaying a composite market depth ladder made up of multiple instruments, Synthetically displaying groups of instruments as a single instrument on account statements, and Single click execution of orders to close out basket.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A method for establishing a user-configurable portfolio basket, said method including:
providing a plurality of pre-determined, user-selectable portfolio baskets, wherein said portfolio baskets include a plurality of products of at least one asset class;
receiving a selection of one of said pre-determined portfolio baskets by a user;
displaying said plurality of products and said at least one asset class associated with said pre-determined portfolio basket;
allowing said user to select a lower delta, an upper delta, and a time selection to be associated with said basket;
determining a portfolio basket including at least one trading instrument for each of said plurality of products using said lower delta, upper delta, and time selection;
performing a trading check on said trading instruments to confirm that said user is authorized to trade said instruments; and
initiating a trade of said instruments to establish said portfolio basket of said instruments.

2. The method of claim 1 further including allowing said user to select a long or short future, option, or option spread with regard to at least one of said plurality of products.

3. The method of claim 1 further including allowing said user to adjust the ratio of the number of contract of said plurality of products relative to each other.

4. The method of claim 1 further including allowing said user to add additional products to said plurality of products.

5. The method of claim 1 further including allowing said user to remove products from said plurality of products.

6. The method of claim 1 wherein at least one of said products is structured as a vertical option spread trade including both the purchase of an option or options contract and the sale of an option or options contract.

7. The method of claim 1 further including, after determining said at least one trading instrument for said plurality of product, displaying an indication of possible outcomes for said portfolio basket.

8. The method of claim 1 further including displaying a break even movement for the instruments comprising at least one product.

9. The method of claim 1 further including allowing said user to establishing a resting order before initiating said trade of said instruments.

10. The method of claim 9 wherein said resting order is determined based on a user-selected percentage of the maximum gain of a product.

11. A system for establishing a user-configurable portfolio basket, said system including:
a basket construction system providing a plurality of pre-determined, user-selectable portfolio baskets, wherein said portfolio baskets include a plurality of products of at least one asset class;
a web server system receiving a selection of one of said pre-determined portfolio baskets from a user and displaying said plurality of products and said at least one asset class associated with said pre-determined portfolio basket,
wherein said web server system allows said user to select a lower delta, an upper delta, and a time selection to be associated with said basket,
wherein said basket construction system receives said lower delta, upper delta, and time selection from said web server system and determines a portfolio basket including at least one trading instrument for each of said plurality of products using said lower delta, upper delta, and time selection;
a pre-trade risk system receiving said portfolio basket and performing a trading check on said trading instruments to confirm that said user is authorized to trade said instruments; and
an exchange message processing system initiating a trade of said instruments to establish said portfolio basket of said instruments.

12. The system of claim 1 wherein said basket construction system allows said user to select a long or short future, option, or option spread with regard to at least one of said plurality of products.

13. The system of claim 11 wherein said basket construction system allows said user to adjust the ratio of the number of contract of said plurality of products relative to each other.

14. The system of claim 11 wherein said basket construction system allows said user to add additional products to said plurality of products.

15. The system of claim 11 wherein said basket construction system allows said user to remove products from said plurality of products.

16. The system of claim 11 wherein at least one of said products is structured as a vertical option spread trade including both the purchase of an option contract or contracts and the sale of an option contract or contracts.

17. The system of claim 11 further including a basket analytics system that displays an indication of possible outcomes for said portfolio basket.

18. The system of claim 11 wherein said basket construction system displays a break even movement for the instruments comprising at least one product.

19. The system of claim 11 wherein said basket construction system allows said user to establishing a resting order before initiating said trade of said instruments.

20. The system of claim 19 wherein said resting order is determined based on a user-selected percentage of the maximum gain of a product.
